(19) United States
(12) Patent Application Publication
(10) Pub. No.: US 2025/0067528 A1
(43) Pub. Date: Feb. 27, 2025

(54) TRITIUM SHUNT HEAT EXCHANGER WITH SWEEP GAS

(71) Applicant: Commonwealth Fusion Systems LLC, Devens, MA (US)

(72) Inventors: Matthew Vernacchia, Cambridge, MA (US); James Logan, Cambridge, MA (US)

(73) Assignee: Commonwealth Fusion Systems LLC, Devens, MA (US)

(21) Appl. No.: 18/944,319

(22) Filed: Nov. 12, 2024

Related U.S. Application Data
(63) Continuation of application No. PCT/US2023/022673, filed on May 18, 2023.
(60) Provisional application No. 63/344,329, filed on May 20, 2022.

(51) Int. Cl. F28F 21/00; F28F 1/00

(52) U.S. Cl. CPC F28F 21/00; F28F 1/00

(57) ABSTRACT

Certain aspects of the present disclosure are generally directed to tritium shunt heat exchangers that use a sweep gas. In some aspects, a heat exchanger system for a fusion power plant is disclosed herein. The system may advantageously allow for efficient energy and tritium extraction from a tritium-containing fluid, while minimizing tritium leakage into the environment. For example, the system may comprise components, such as a thermally conductive solid connector, a sweep gas, reactive materials, etc., that allow for high heat transfer efficiency, and/or high tritium removal and extraction efficiency. In addition, some aspects of the disclosure are directed to methods for using or making such a system.

### RELATED APPLICATIONS

This application claims the benefit of U.S. Provisional Patent Application Ser. No. 63/344,329, filed May 20, 2022, entitled “Tritium Shunt Heat Exchanger with Sweep Gas,” incorporated herein by reference in its entirety.

### FIELD

Certain aspects of the present disclosure are generally directed to tritium shunt heat exchangers that use a sweep gas.

### BACKGROUND

Fusion plants utilize the processes of fusion reactions for power generation. Energy produced by fusion reactions may be transferred via a heat exchanger to a processing fluid for subsequent power generation. Although fusion power plants offer a promising source of energy, one safety concern is the potential for the production of high levels of tritium. For example, tritium, due to its high diffusivity, can leak into the processing fluid or into the surrounding environment. Current heat exchangers and other equipment typically lack the ability to address this issue, as they are often not constructed for handling radioactive materials. Thus, more effective heat exchangers for fusion power plants capable of efficient energy transfer while ensuring minimal tritium leakage are still needed.

### SUMMARY

Certain aspects of the present disclosure are generally directed to tritium shunt heat exchangers that use a sweep gas. The subject matter of the present disclosure involves, in some cases, interrelated products, alternative solutions to a particular problem, and/or a plurality of different uses of one or more systems and/or articles.

One aspect of the present disclosure is generally directed to a heat exchanger system. According to one set of embodiments, the heat exchanger system comprises a first conduit; a second conduit; a solid connector thermally coupling an external surface of the first conduit to an external surface of the second conduit; and a gas flow device, positioned to flow a gas around the first conduit, the second conduit, and the solid connector.

According to another set of embodiments, the heat exchanger system comprises a first conduit containing a primary fluid, wherein the primary fluid comprises tritium; a second conduit containing a secondary fluid, wherein the secondary fluid comprises tritium at a lower concentration than the primary fluid; a solid connector thermally coupling an external surface of the first conduit to an external surface of the second conduit; and a sweep gas surrounding the first conduit, the second conduit, and the solid connector, wherein the sweep gas contains tritium arising from the primary fluid.

In yet another set of embodiments, the heat exchanger system comprises a first conduit containing a primary fluid, wherein the primary fluid comprises tritium; a second conduit thermally coupled to the first conduit, wherein the second conduit contains a secondary fluid; and a reactive material positioned externally of the first conduit and the second conduit to react with tritium exiting an external surface of the first conduit.

In yet another set of embodiments, the heat exchanger system comprises a plurality of first conduits, at least some of which contain a primary fluid, wherein the primary fluid comprises tritium; a plurality of second conduits thermally coupled to the plurality of first conduits, wherein at least one of the plurality of first conduits is thermally coupled to two or more of the plurality of second conduits and/or at least one of the plurality of second conduits is thermally coupled to two or more of the plurality of first conduits; and a sweep gas surrounding the plurality of first conduits and the plurality of second conduits, wherein the sweep gas contains tritium arising from the primary fluid.

Another aspect is generally directed to a method. In some embodiments, the method comprises passing a primary fluid comprising tritium into a first conduit of a heat exchanger; directing, via a connector, heat from the primary fluid to a secondary fluid contained within the second conduit of the heat exchanger, wherein the connector thermally couples an external surface of the first conduit to an external surface of a second conduit; and flowing a sweep gas around the first conduit, the second conduit, and the connector to remove tritium from the primary fluid and the connector.

Another aspect is generally directed to a method of manufacturing a heat exchanger system. The method comprises forming a plurality of first conduits; forming at least one solid connector; forming a plurality of second conduits; and stacking the plurality of first conduits, the at least one solid connector, and the plurality of second conduits in alternating layers such that the at least one solid connector thermally couples the plurality of first conduits to the plurality of second conduits.

Other advantages and novel features of the present disclosure will become apparent from the following detailed description of various non-limiting embodiments of the disclosure when considered in conjunction with the accompanying figures.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1A is a schematic representation of a side view of a heat exchanger system, according to some embodiments;

FIG. 1B-1C are schematic representations of a cross-sectional view of the heat exchanger system of FIG. 1A, according to some embodiments;

FIG. 2 is a schematic representation of a cross-sectional view of a heat exchanger system having a first configuration, according to some embodiments;

FIG. 3 is a schematic representation of a cross-sectional view of a heat exchanger system having a second configuration, according to some embodiments;

FIG. 4 is a schematic representation of a cross-sectional view of a heat exchanger system having a third configuration, according to some embodiments;

FIG. 5 is a schematic representation of a cross-sectional view of a heat exchanger system having a fourth configuration, according to some embodiments;

FIG. 6A is a schematic representation of a cross-sectional view of a heat exchanger unit, according to some embodiments;

FIG. 6B is a schematic representation of a cross-sectional view of a heat exchanger unit of FIG. 6A having a coiled configuration, according to some embodiments;

FIG. 6C is a schematic representation of a side view of the heat exchanger unit of FIG. 6B, according to some embodiments;

FIG. 6D is a schematic representation of a top view of a heating exchanger system comprising a manifold, according to some embodiments;

FIG. 7 is a flow chart illustrating a method of manufacturing a heat exchanger system, according to some embodiments;

FIG. 8 is a flow chart illustrating a method of using a heat exchanger system, according to some embodiments;

FIG. 9 is a schematic representation of a fusion power plant comprising a heat exchanger system, according to some embodiments; and

FIG. 10A-10B are schematic representations of cross-sectional views of a heat exchanger system comprising alternating layers of tubes and copper sheets, according to some embodiments.

### DETAILED DESCRIPTION

Certain aspects of the present disclosure are generally directed to tritium shunt heat exchangers that use a sweep gas. In some aspects, a heat exchanger system for a fusion power plant is disclosed herein. The system may advantageously allow for efficient energy and tritium extraction from a tritium-containing fluid, while minimizing tritium leakage into the environment. For example, the system may comprise components, such as a thermally conductive solid connector, a sweep gas, reactive materials, etc., that allow for high heat transfer efficiency, and/or high tritium removal and extraction efficiency. In addition, some aspects of the disclosure are directed to methods for using or making such a system.

For instance, some aspects of the present disclosure are generally directed to heat exchange systems where it is desired to transfer heat from a primary fluid carrying radioactive tritium to a secondary fluid without also transferring significant amounts of tritium to the secondary fluid (which can create problems in terms of being able to subsequently process the secondary fluid, e.g., if it also becomes radioactive). For example, the primary fluid may be a molten lithium salt that is used to capture neutrons, converting ⁶Li within the lithium salt to ³H or T (tritium) and ⁴He (helium), while the secondary fluid may be, for example, water or another fluid that is subsequently used to produce energy.

As mentioned, tritium is an isotope of hydrogen and is radioactive; however, due to its small size (being a hydrogen atom), it can diffuse very quickly through most materials due to its extremely small size, unlike most other substances. Thus, tritium may readily diffuse through materials used to contain the primary fluid or form a heat transfer connector, for example, iron or stainless steel. Accordingly, while a heat transfer connector can be used as a conduit to transfer heat between the primary fluid and the secondary fluid, tritium may also diffuse through the solid connector from the primary fluid to the secondary fluid as well, which may render the secondary fluid unacceptably radioactive. One could decrease the amount of tritium diffusion by separating the primary fluid and the secondary fluid by a longer distance, e.g., by using a longer connector. However, doing so would not only decrease the amount of tritium that is able to transfer between the primary fluid and the second fluid, it could also decrease the amount of heat transfer as well. Accordingly, systems able to transfer heat while minimizing the transfer of tritium are needed.

Thus, various heat exchanger systems described herein may allow, in certain embodiments, for efficiently recovery of energy from a primary fluid containing energy released from fusion reactions (e.g., containing energy including heat energy and tritium from captured neutrons). In some cases, the heat exchanger systems are designed to allow tritium to leave heat connectors thermally coupling a first conduit containing a primary fluid and a second conduit containing a secondary fluid by creating a “sink” to remove the tritium, for example, due to a sweep gas that flows around the connector and/or one or more reactive materials that can react with the tritium, for example, by reacting tritium to form water, ammonia, methane, or other substances.

For example, the heat exchanger system may comprise components and/or have particular configurations that allows for harnessing of energy produced from fusion reactions while preventing or minimizing energy loss due to loss of waste heat. The heat exchanger system may comprise, in one embodiment, a thermally conductive solid connector coupling various heat exchanger conduits (e.g., a first conduit and a second conduit) containing a primary fluid (e.g., a fluid containing molten lithium and tritium) and a secondary fluid (e.g., a process fluid, such as water). The solid connector may have a particular configuration and/or property that allows for efficient heat transfer.

Additionally, the heat exchanger system may, in certain embodiments, prevent or reduce tritium from leaking from the heat exchanger. As mentioned, tritium, due to its small size, has a surprisingly high diffusivity, and can pass or diffuse through many materials relatively quickly. Thus, for example, the heat exchanger system may comprise various configurations and/or components that enhance heat recovery while reducing or minimizing tritium leakage. For instance, the heat exchanger system may, in certain embodiments, comprise a tritium sink, such as a sweep gas (for example, air, nitrogen, carbon dioxide, or the like) and/or a reactive material (e.g., a material capable of reacting with tritium) capable of removing at least some of the tritium exiting or leaking from the primary fluid, e.g., such that a small or negligible amount of the tritium from the primary fluid leaks into the secondary fluid. Additionally or alternatively, in some embodiments, various heat exchanger conduits and connectors may be arranged in particularly beneficial configurations, e.g., such as in alternating layers, that impart the heat exchanger system with enhanced heat transfer and/or tritium removal capabilities.

In some embodiments, the heat exchanger system may be particularly useful in a fusion power plant, e.g., such as a tokamak, for extraction and recycling of tritium. In a fusion reactor, a fusion reaction, e.g., such as a fusion reaction between deuterium (²H) and tritium (³H or T), may be carried out to produce neutrons (¹n) and helium (He). A significant amount of the energy produced from the fusion reactions is available in the form of kinetic energy of the neutrons. To ensure an adequate supply of tritium, it may also be beneficial to breed additional tritium from the neutrons, e.g., to be recycled for use within the fusion reaction. For example, neutrons (e.g., see eq. (1)) may be sent to a fluid containing lithium, such that the neutrons may participate in a reaction to produce additional tritium (e.g., see eq. (2)). The produced tritium may be recycled to the deuterium-tritium fusion reaction to generate additional neutrons. During this process, the energy associated with the neutrons may be converted into thermal energy, which may be harnessed by the heat exchanger system described herein.

$${}^{2} H + {}^{3} H \to {}^{4} {He}_{( g )} + {}^{1} n \qquad ( 1 )$$

$${}^{1} n + {}^{6} Li \to {}^{3} {H}_{( recycled )} + {}^{4} {He}_{( g )} \qquad ( 2 )$$

In some embodiments relating to fusion reactions (e.g., the reactions shown in eqs. (1)-(2)), in addition to harnessing energy from fusion reactions and minimizing amount of tritium leakage, the heat exchanger system may have one or more advantages over conventional heat exchanger systems. For example, the heat exchanger system described herein may help extract and recycle tritium for use in subsequent fusion reactions.

While various embodiments herein are described as employing the heat exchanger system in a fusion plant, it should be understood that the disclosure is not so limited, and in certain cases, the heat exchanger system may be employed in any of a variety of suitable power plants, chemical plants, etc. to recover heat produced from any appropriate type of reactions.

Thus, certain aspects are discussed herein are generally directed to heat exchangers where, between a first conduit containing a primary fluid comprising tritium, and a second conduit containing a secondary fluid is a heat transfer conduit or connector that allows the transfer of heat from the primary fluid to the second fluid, but minimizes or reduces the amount of tritium exiting the primary fluid (i.e., due to its high diffusivity and small size) and enters the secondary fluid. As discussed herein, various embodiments are used to create a tritium sink to minimize the ability of tritium to reach the secondary fluid. For example, in one embodiment, a sweep gas may be used to remove tritium that diffuses outwardly, e.g., within the connector. In another embodiment, a reactive material may be used to react with the tritium. The reactive material may be present on a conduit or in or on the connector, present within the sweep gas, etc.

In some embodiments, the connector (e.g., a solid connector) is constructed and arranged such that a substantial amount of the tritium exiting the primary fluid diffuses into the sweep gas before reaching the secondary fluid. For example, in some cases, at least 50% (e.g., at least 55%, at least 60%, at least 70%, at least 80%, at least 85%, at least 90%, at least 92.5%, at least 95%, at least 97.5%, at least 99%, at least 99.5%, at least 99.9%, at least 99.95%, at least 99.99%, or all) of the tritium exiting the primary fluid diffuses into the sweep gas before reaching the secondary fluid. As described in more detail below, in certain embodiments, the solid connector may have a particularly advantageous dimension, material property (e.g., permeability to tritium, tritium diffusivity, etc.), and/or configuration, e.g., such that a substantial amount of the tritium exiting the primary fluid diffuse into the sweep gas.

The solid connector may comprise any of a variety of appropriate materials. In some cases, the solid connector may comprise a material having a thermal conductivity, a permeability to tritium, and/or a ratio of thermal conductivity to tritium permeability, in one or more of the ranges described herein. In certain cases, the solid connector may have a relatively low permeability to tritium. In some embodiments, the solid connector may include, for example, a conductive metal or metal alloy. As non-limiting examples, metals and/or metal alloys used in the solid connector may include copper, nickel, tungsten, molybdenum, copper alloys, nickel alloys, nickel-chromium alloys, nickel-copper alloys, iron-nickel-chromium alloys (e.g. stainless steel), as well as any combinations of these and/or other metals. It should be understood, however, other thermally conductive materials may also be employed, as long as the material a suitable thermal conductivity, a permeability to tritium, and/or a ratio of thermal conductivity to tritium permeability in one or more of the ranges described herein.

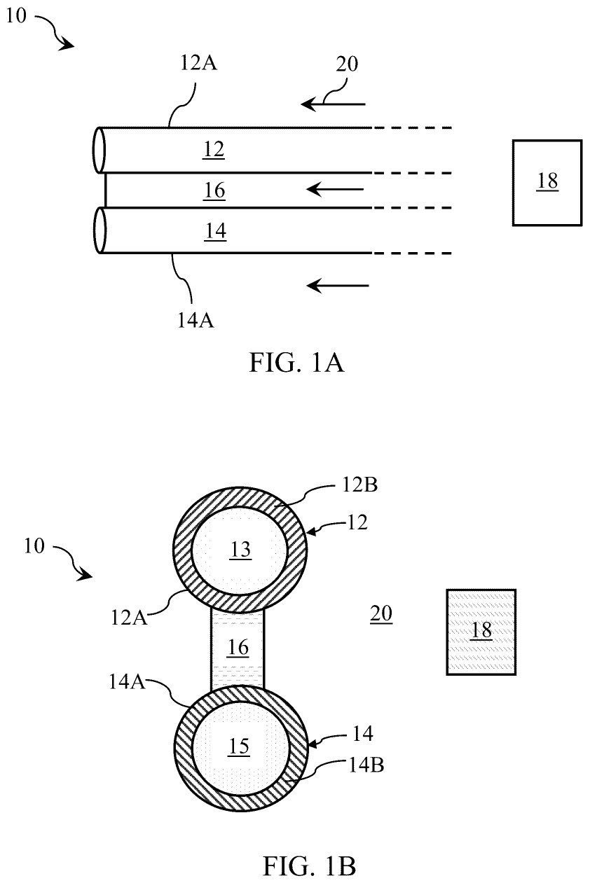

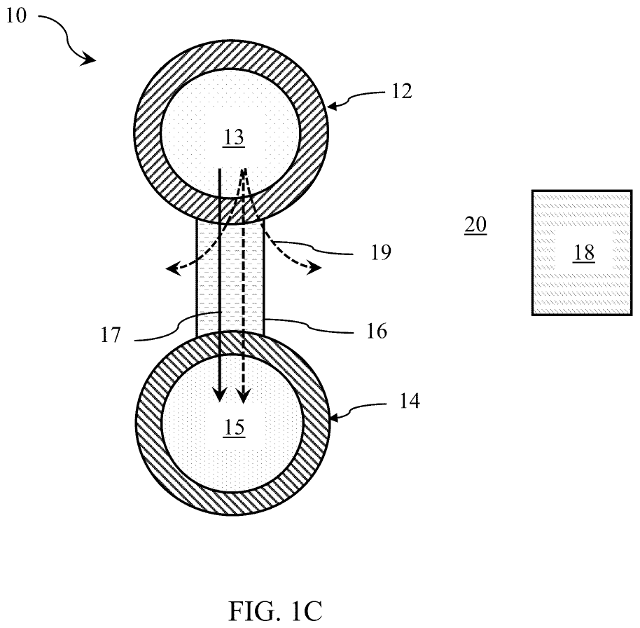

The connector (e.g., a solid connector) described herein may have any of a variety of appropriate dimensions. For example, in some cases, the connector may have a particular ratio of an external surface area to a cross-sectional area. For example, as shown in FIGS. 1A-6, the connector may have an external surface that is exposed to the sweep gas. The connector may further have a cross-section perpendicular to a direction along which the connector extends from the first conduit to the second conduit. In some embodiments, a ratio of the external surface area to a cross-sectional area of the connector is at least 0.5, at least 1, at least 1.5, at least 2, at least 4, at least 6, or at least 8. In some embodiments, a ratio of the external surface area to a cross-sectional area of the connector is no more than 10, no more than 8, no more than 6, no more than 4, no more than 2, no more than 1.5, or no more than 1. Any of the above-referenced ranges are possible (e.g., at least 0.5 and no more than 10). Other ranges are also possible.

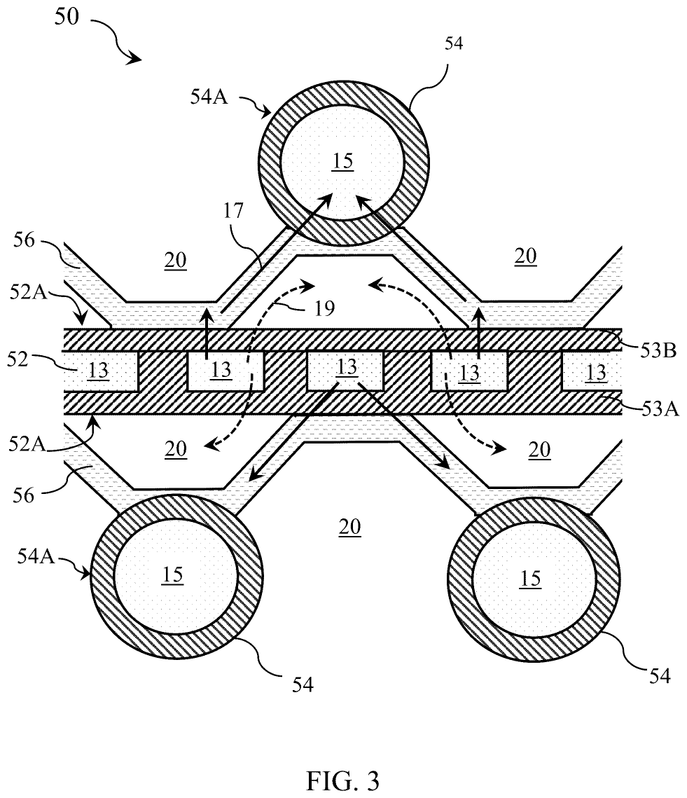

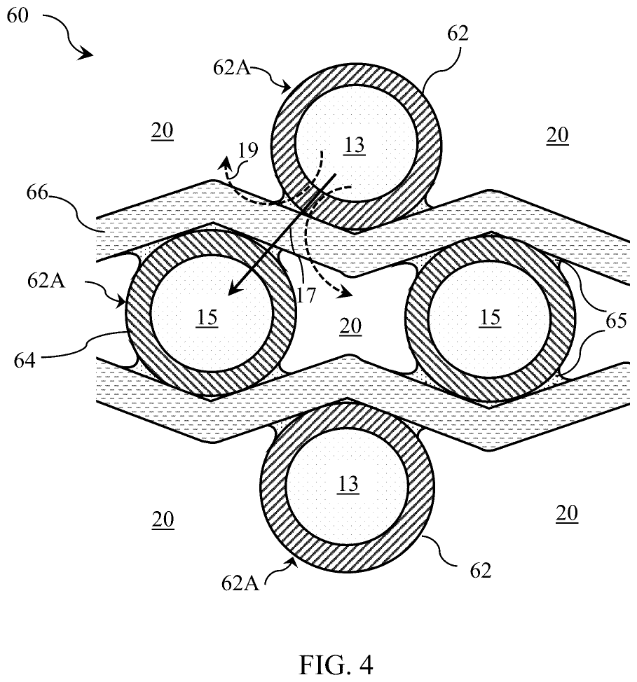

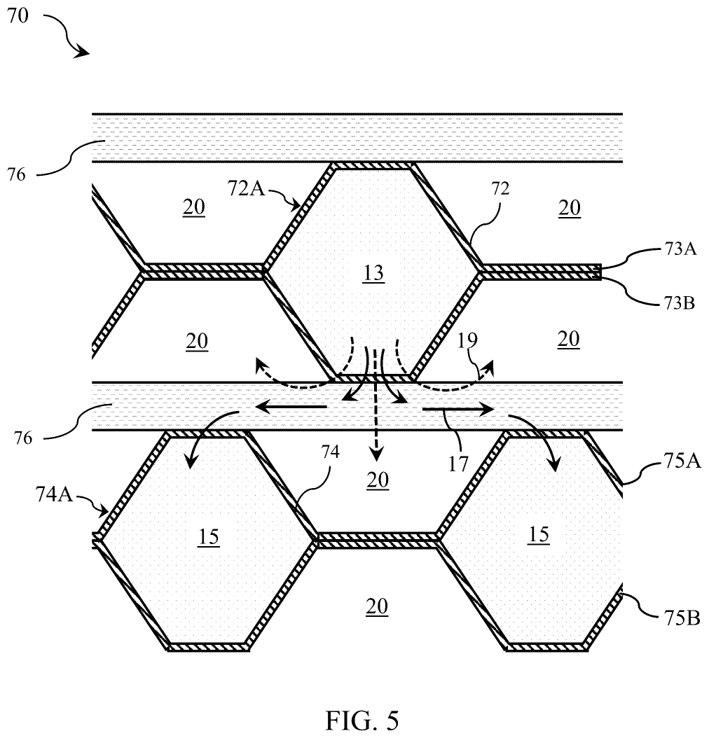

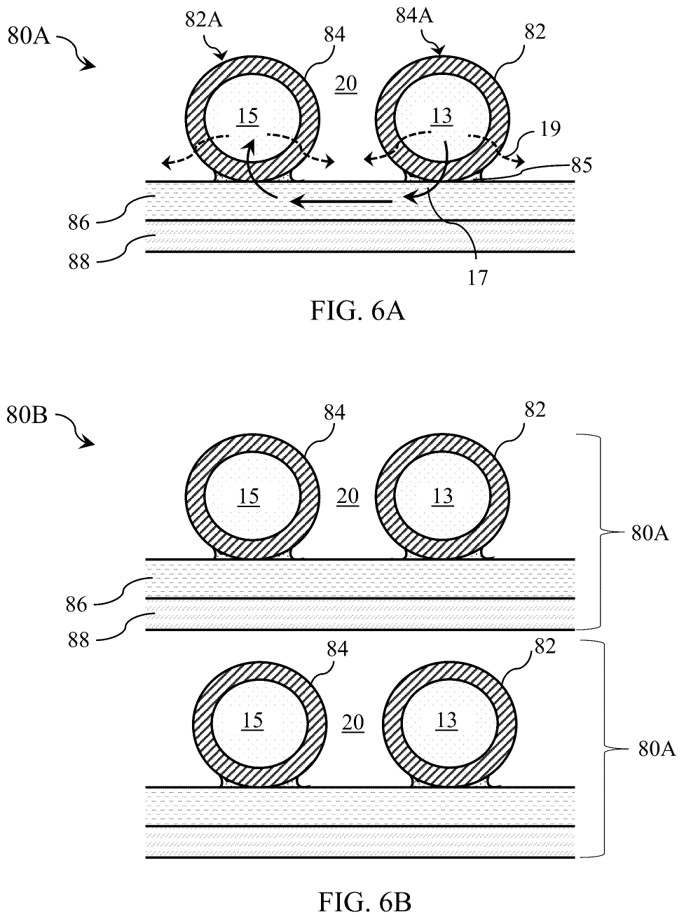

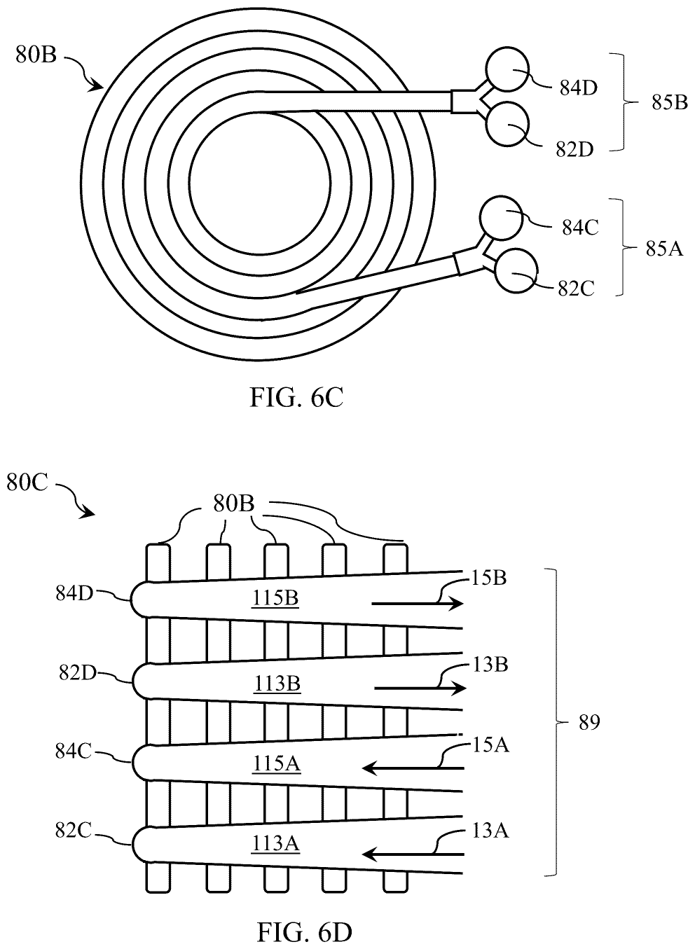

The connector may have any of a variety of shapes and configurations described herein. In some instances, the connector may have the shape of be a flat sheet, e.g., as shown in FIGS. 5-6. In other instances, the connector may have the shape of a corrugated sheet, as shown in FIGS. 3-4. Other shapes and configurations are also possible.

The connector (e.g., a solid connector) described herein may have any of a variety of suitable thermal conductivity values. In some embodiments, the solid connector have a relatively high thermal conductivity. In some embodiments, the solid connector may have a thermal conductivity of at least 10 W m⁻¹ K⁻¹, at least 20 W m⁻¹ K⁻¹, at least 30 W m⁻¹ K⁻¹, at least 40 W m⁻¹ K⁻¹, at least 50 W m⁻¹ K⁻¹, at least 60 W m⁻¹ K⁻¹, at least 80 W m⁻¹ K⁻¹, at least 100 W m⁻¹ K⁻¹, at least 150 W m⁻¹ K⁻¹, at least 200 W m⁻¹ K⁻¹, at least 250 W m⁻¹ K⁻¹, at least 300 W m⁻¹ K⁻¹, at least 350 W m⁻¹ K⁻¹, or at least 380 W m⁻¹ K⁻¹ at a temperature of between 700 K to 900 K (e.g., about or equal to 800 K, about or equal to 850 K, etc.). In some embodiments, the connector (e.g., a solid connector) may have a thermal conductivity of no more than 400 W m⁻¹ K⁻¹, no more than 380 W m⁻¹ K⁻¹, no more than 350 W m⁻¹ K⁻¹, no more than 300 W m⁻¹ K⁻¹, no more than 250 W m⁻¹ K⁻¹, no more than 200 W m⁻¹ K⁻¹, no more than 150 W m⁻¹ K⁻¹, no more than 100 W m⁻¹ K⁻¹, no more than 80 W m⁻¹ K⁻¹, no more than 60 W m⁻¹ K⁻¹, at least 50 W m⁻¹ K⁻¹, at least 40 W m⁻¹ K⁻¹, no more than 30 W m⁻¹ K⁻¹, or no more than 20 W m⁻¹ K⁻¹ at a temperature of between 700 K to 900 K (e.g., about or equal to 800 K, about or equal to 850 K, etc.). Combination of the above-referenced range are possible (at least 20 W m⁻¹ K⁻¹ and no more than no more than 380 W m⁻¹ K⁻¹). Other ranges are also possible.

In some embodiments, the solid connector may have any of a variety of suitable permeabilities to tritium. In some embodiments, the solid connector have a relatively low tritium permeability, e.g., such that a negligible amount, if any, of tritium permeates through the solid connector from the first fluid to the secondary fluid. The solid connector, for example, may have a tritium permeability of no more than 10¹ mol m⁻¹ s⁻¹ MPa⁻¹, no more than 10⁻⁶ mol m⁻¹ s⁻¹ MPa^{-1/2}, no more than 10⁻⁷ mol m⁻¹ s⁻¹ MPa^{-1/2}, no more than 10⁻⁸ mol m⁻¹ s⁻¹ MPa^{-1/2}, no more than 10⁻⁹ mol m⁻¹ s⁻¹ MPa^{-1/2}, no more than 10⁻¹⁰ mol m⁻¹ s⁻¹ MPa^{-1/2}, no more than 10⁻¹¹ mol m⁻¹ s⁻¹ MPa^{-1/2}, no more than 10⁻¹² mol m⁻¹ s⁻¹ MPa^{-1/2}, no more than 10⁻⁴ mol m⁻¹ s⁻¹ MPa^{-1/2}, or no more than 10⁻¹⁶ mol m⁻¹ s⁻¹ MPa^{-1/2}, at a temperature of between 700 K to 900 K (e.g., about or equal to 800 K, about or equal to 850 K, etc.). In some embodiments, the solid connector may have a tritium permeability of at least 10⁻²⁰ mol m⁻¹ s⁻¹ MPa^{-1/2}, at least 10⁻¹⁶ mol m⁻¹ s⁻¹ MPa^{-1/2}, at least 10⁻⁴ mol m⁻¹ s⁻¹ MPa^{-1/2}, at least 10⁻¹² mol m⁻¹ s⁻¹ MPa^{-1/2}, at least 10⁻¹¹ mol m⁻¹ s⁻¹ MPa^{-1/2}, at least 10⁻¹⁰ mol m⁻¹ s⁻¹ MPa^{-1/2}, at least 10⁻⁹ mol m⁻¹ s⁻¹ MPa^{-1/2}, at least 10⁻⁸ mol m⁻¹ s⁻¹ MPa^{-1/2}, at least 10⁻⁷ mol m⁻¹ s⁻¹ MPa^{-1/2}, or at least 10⁻⁹ mol m⁻¹ s⁻¹ MPa⁻¹, at a temperature of between 700 K to 900 K (e.g., about or equal to 800 K, about or equal to 850 K, etc.). Any of the above-referenced ranges are possible (e.g., at least 10⁻²⁰ mol m⁻¹ s⁻¹ MPa^{-1/2} and no more than 10⁻⁶ mol m⁻¹ s⁻¹ MPa^{-1/2}). Other ranges are also possible. In one set of embodiments, the solid connector has a permeability to tritium of no more than 10⁻⁶ mol m⁻¹ s⁻¹ MPa^{-1/2}.

The solid connector described herein may have any of a variety of appropriate ratios of thermal conductivity to tritium permeability. In some cases, the solid connector may have a relatively high ratio of thermal conductivity to tritium permeability. A solid connector having a relatively high ratio of thermal conductivity to tritium permeability may, for example, allow for efficient heat transfer and from the primary fluid to the secondary fluid while minimizing tritium permeation across the solid connector. In some embodiments, the solid connector may have a ratio of thermal conductivity to tritium permeability of at least 10¹⁰ N^{3/2} mol⁻¹ K⁻¹, at least 2·10¹⁰ N^{3/2} mol⁻¹ K⁻¹, at least 5·10¹⁰ N^{3/2} mol⁻¹ K⁻¹, at least 10¹¹ N^{3/2} mol⁻¹ K⁻¹, at least 2·10¹¹ N^{3/2} mol⁻¹ K⁻¹, at least 4·10¹¹ N^{3/2} mol⁻¹ K⁻¹, at least 10¹² N^{3/2} mol⁻¹ K⁻¹, at least 10¹⁴ N^{3/2} M mol⁻¹ K⁻¹, at least 10¹⁶ N^{3/2} mol⁻¹ K⁻¹, or at least 10¹⁸N^{3/2} mol⁻¹ K⁻¹, at a temperature of between 700 K to 900 K (e.g., about or equal to 800 K, about or equal to 850 K, etc.). In some embodiments, the solid connector may have a ratio of thermal conductivity to tritium permeability of up to 10¹¹ N^{3/2} mol⁻¹ K⁻¹, up to 2·10¹¹ N^{3/2} mol⁻¹ K⁻¹, up to 4·10¹¹ N^{3/2} mol⁻¹ K⁻¹, up to 10¹² N^{3/2} mol⁻¹ K⁻¹, up to 10¹⁴ N^{3/2} mol⁻¹ K⁻¹, up to 10¹⁶ N^{3/2} mol⁻¹ K⁻¹, up to 10¹⁸ N^{3/2} mol⁻¹ K⁻¹, up to 10²⁰ N^{3/2} mol⁻¹ K⁻¹, or up to 10²¹ N^{3/2} mol⁻¹ K⁻¹, at a temperature of between 700 K to 900 K (e.g., about or equal to 800 K, about or equal to 850 K, etc.). Combination of the above-referenced range are possible (at least 2·10¹⁰ N^{3/2} mol⁻¹ K⁻¹ and up to 10²¹ N^{3/2} mol⁻¹ K⁻¹). Other ranges are also possible.

Thus, in some embodiments, the method comprises directing, via a connector, heat from the primary fluid to a secondary fluid contained within the second conduit of the heat exchanger. For example, as described herein, the heat exchanger system may comprise a connector (e.g., a solid connector) thermally coupling an external surface of the first conduit to an external surface of a second conduit.

Referring to FIGS. 1A-6D, for example, in a heat exchanger system (e.g., system 10, 30, 50, 60, 70, 80), via a connector (e.g., connector 16, 36, 56, 66, 76, 86), heat from the primary fluid (e.g., fluid 13) contained within a first conduit (e.g., conduit 12, 32, 52, 62, 72, 82) may be directed to a secondary fluid (e.g., fluid 15) contained within a second conduit (e.g., second conduit 14, 34, 54, 64, 74, 84).

In some embodiments, the heated secondary fluid may exit the heat exchanger system into the environment and may be subsequently used in various power turbines and/or generators for power generation. Non-limiting examples of power generators include steam turbine, supercritical carbon dioxide turbine, etc.

The tritium exiting the external surface of the first conduit may be removed by the sweep gas in any appropriate manner, in accordance with one set of embodiments. For example, the tritium may be removed by physical forces, and/or chemical reactions, etc.

In some embodiments, the tritium from the primary fluid may be removed sweep gas via physical forces (e.g., forced advection, etc.). In some embodiments, the sweep gas may have any appropriate flowrate, tritium partial pressure, etc., that facilitates removal of the tritium exiting the first conduit. For example, in one set of embodiments, a sweep gas having a relatively low tritium partial pressure, e.g., such that the sweep gas acts as a tritium sink and drives diffusion of the tritium into the sweep gas. Alternatively or additionally, the sweep gas may have a relatively high flow rate, e.g., such that the tritium exiting the external surface of the first conduit may be advected away from the surface of the first conduit. In some embodiments, sweep gas may include an inert gas, e.g., a gas that that is inert (e.g., non-reactive) in the presence of tritium. Non-limiting examples of an inert gas may include, helium, argon, neon, krypton, etc. However, the sweep gas may include air in another embodiment. In yet other embodiments, the sweep gas may include nitrogen, carbon dioxide, oxygen, or the like. Such sweep gases need not react with tritium, but can act in some embodiments as a physical technique to remove tritium.

Thus, in some embodiments, the method comprises flowing a sweep gas around the first conduit, the second conduit, and the connector to remove tritium from the primary fluid and the connector. In some embodiments, as the tritium from the primary fluid exits through the external surface of the first conduit and/or the connector, the sweep gas may facilitate removal of the tritium from the primary fluid and the connector. Without wishing to be bound by theory, the sweep gas, by facilitating removal of tritium from the primary fluid and the connector, may substantially reduce the amount of tritium available to permeate into the secondary fluid contained within the second conduit, e.g., by creating a “sink” for the tritium away from the connector.

Referring to FIGS. 1A-6D, a heat exchanger (e.g., systems 10, 30, 50, 60, 70, 80) may comprise a sweep gas (e.g., gas 20). As the tritium from the primary fluid exits and/or permeates through the first conduit and/or the connector (e.g., as shown by flow arrow 19), the sweep gas may facilitate removal of the exiting tritium. In some instances, the sweep gas (e.g., gas 20) may be flowed around the first conduit (e.g., first conduit 12, 32, 52, 62, 72, 82), the second conduit (e.g., second conduit 14, 34, 54, 64, 74, 84), and the connector (e.g., connector 16, 36, 56, 66, 76, 86) to remove tritium from the primary fluid (e.g., fluid 13) and the connector (e.g., connector 16, 36, 56, 66, 76, 86).

In some embodiments, the sweep gas may remove a substantial amount of tritium exiting (e.g., permeating through) an external surface of the first conduit. For example, referring back to FIGS. 1A-6D, a substantial amount of the tritium exiting an external surface (e.g., surface 12A, 32A, 52A, 62A, 72A, 82A) of the first conduit (e.g., first conduit 12, 32, 52, 62, 72, 82) may be removed, e.g., as shown by flow arrow 19, by the surrounding sweep gas (e.g., gas 20). In some instances, at least 50% (e.g., at least 55%, at least 60%, at least 70%, at least 80%, at least 85%, at least 90%, at least 92.5%, at least 95%, at least 97.5%, at least 99%, at least 99.5%, at least 99.9%, at least 99.95%, at least 99.99%, or all) of the tritium (by mass) exiting (e.g., permeating through) an external surface of the first conduit may be removed by the sweep gas. In one set of embodiments, the sweep gas may remove at least 90% by mass of tritium exiting an external surface of the first conduit.

In some embodiments, the sweep gas may include an inert gas (e.g., a gas that is unreactive to tritium) and/or a reactive gas (e.g., a gas that reacts with tritium to form a tritium-containing reaction product). In some embodiments, the sweep gas may further be associated with a reactive solid or a solid catalyst that is contained within a space the sweep gas resides. The solid catalyst, in some cases, may accelerate a reaction between the reactive gas and the tritium exiting the external surface of the first conduit. Non-limiting examples of a solid catalyst include various noble metals (e.g., platinum, palladium, silver, etc.) and/or metal oxides (e.g., CuO, NiO, Co₃O₄, MnO₂, etc.). In some embodiments, the sweep comprises a gas having a relatively low thermal conductivity.

In some embodiments, the sweep gas described herein may have a particular set of properties, e.g., flow rate, tritium partial pressure, reactivity with tritium, etc., such that a substantial amount of the tritium exiting an external surface of the first conduit and/or connector may be removed. For example, in one set of embodiments, least 50% (e.g., at least 55%, at least 60%, at least 70%, at least 80%, at least 85%, at least 90%, at least 92.5%, at least 95%, at least 97.5%, at least 99%, at least 99.5%, at least 99.9%, at least 99.95%, at least 99.99%, or all) of the tritium exiting (e.g., permeating through) an external surface of the first conduit may be removed by the sweep gas.

In some embodiments, the sweep gas may have a relatively high flow rate. In some embodiments, the sweep gas may have a flowrate of at least 0.01 m³/s per megawatt, at least 0.1 m³/s per megawatt, at least 1 m³/s per megawatt, at least 10 m³/s per megawatt, at least 50 m³/s per megawatt, at least 100 m³/s per megawatt, at least 200 m³/s per megawatt, at least 400 m³/s per megawatt, at least 600 m³/s per megawatt, or at least 800 m³/s per megawatt, of heat-exchange capacity. In some embodiments, the sweep gas may have a flowrate of no more than 1000 m³/s per megawatt, no more than 800 m³/s per megawatt, no more than 600 m³/s per megawatt, no more than 400 m³/s per megawatt, no more than 200 m³/s per megawatt, no more than 100 m³/s per megawatt, no more than 50 m³/s per megawatt, no more than 10 m³/s per megawatt, no more than 1 m³/s per megawatt, or no more than 0.1 m³/s per megawatt, of heat-exchange capacity. Combinations of the above-referenced ranges are possible (e.g., at least 0.01 m³/s per megawatt and no more than 1000 m³/s per megawatt of heat-exchange capacity). Other ranges are also possible.

In some embodiments, the sweep gas may have any suitable partial pressure of tritium. In some embodiments, the sweep gas may have a relatively low partial pressure of tritium. In some embodiments, the sweep gas may have a partial pressure of tritium of less than or equal to 100 Pa, less than or equal to 50 Pa, less than or equal to 10 Pa, less than or equal to 5 Pa, less than or equal to 1 Pa, less than or equal to 0.5 Pa, less than or equal to 0.1 Pa, less than or equal to 0.05 Pa, less than or equal to 10⁻² Pa, less than or equal to 10⁻³ Pa, less than or equal 10⁻⁴ Pa, less than or equal to 10⁻⁵ Pa, less than or equal to 10⁻⁶ Pa, less than or equal to 10⁻⁷ Pa, less than or equal to 10⁻⁸ Pa, or less than or equal to 10⁻⁹ Pa. In some embodiments, the sweep gas may have a partial pressure of tritium of greater than or equal to 10⁻¹⁰ Pa, greater than or equal to 10⁻⁹ Pa, greater than or equal to 10⁻⁸ Pa greater than or equal to 10⁻⁷ Pa, greater than or equal to 10⁻⁶ Pa, greater than or equal to 10⁻⁵ Pa, greater than or equal to 10⁻⁴ Pa, greater than or equal to 10⁻³ Pa, greater than or equal to 10⁻² Pa, greater than or equal to 0.05 Pa, greater than or equal to 0.1 Pa, greater than or equal to 0.5 Pa, greater than or equal to 1 Pa, greater than or equal to 5 Pa, greater than or equal to 10 Pa, or greater than or equal to 50 Pa. Combination of the above-referenced ranges are possible (e.g., greater than or equal to 10⁻¹⁰ Pa and less than or equal to 100 Pa). Other ranges are also possible. For example, in some embodiments, the sweep gas may have a partial pressure of tritium of less than or equal to 10⁻⁵ Pa.

In some embodiments, the tritium from the primary fluid may be removed by the sweep gas via a chemical route (e.g., a chemical reaction). For example, the sweep gas may have a certain reactivity toward tritium, e.g., such that at least a portion of the tritium exiting the external surface of the first conduit may be removed (e.g., reacted away) by a reactive material within and/or associated with the sweep gas. For example, in one set of embodiments, the sweep gas may comprise a reactive gas capable of reacting with (e.g., chemically bind with) tritium. Non-limiting examples of a reactive gas include oxygen, carbon dioxide, nitrogen, chlorine, fluorine, etc. In some embodiments, the reactive gas may react with tritium to form one or more tritium-containing reaction products. For example, in one embodiment, oxygen may be reacted with the tritium to form water (i.e., tritiated water). As another example, nitrogen may be reacted with tritium to form ammonia (i.e., tritiated ammonia). In some embodiments, such reactions may occur under reducing conditions (e.g., to facilitate the hydrogenation of a reactive gas such as nitrogen or carbon with hydrogen, i.e., with tritium).

The tritium-containing reaction products may be present in any appropriate form, e.g., as a liquid, gas, and/or solid. Non-limiting examples of tritium-containing reaction products may include, but are not limited to, tritiated water (HTO or T₂O), tritiated ammonia (NH₂T, NHT₂, NT₃), tritiated methane (CH₃T, CH₂T₂, CHT₃, CT₄), tritiated hydrogen chloride (TCl), tritiated hydrogen fluoride (TF), etc. It should be noted that the sweep gas may include any of the various type of gas referenced above, e.g., inert gases and/or reactive gases, to facilitate removal of tritium from the external surface of the first conduit.

While FIGS. 1-6 illustrates various embodiments of a heat exchanger system comprising a sweep gas configurated to remove tritium, it should be noted that the present disclosure is not so limited, and that in other embodiments, the heat exchanger system may, additionally or alternatively, include one or more reactive materials configured to remove tritium. The one or more reactive materials may be positioned in any appropriate location within the heat exchanger system.

For example, in one set of embodiments, the heat exchanger system may comprise one or more reactive materials, e.g., reactive solids and/or reactive liquids, that are configured to remove (e.g., react away) tritium exiting from the surface of the first conduit. For example, in one set of embodiments, a reactive solid and/or reactive liquid may be disposed within a space external the first conduit, the second conduit, and/or the connector. In some embodiments, the heat exchanger system, in addition to comprising the sweep gas, may comprise one or more reactive solids or liquids disposed within a space containing the sweep gas. The one or more reactive solids or liquids may participate in one more reactions with tritium to form any of a variety of tritium-containing reaction products described elsewhere herein. The one or more reactive solids or liquids may include various reactants and/or catalysts described herein. A non-limiting example of a reactive solid is cupper (II) oxide (CuO), e.g., a solid reactant that is capable of reacting with tritium to form tritiated water (HTO or T₂O). Additional examples of various types of solid reactive materials may include iron oxide (e.g., hematite (Fe₂O₃). magnetite (Fe₃O₄), etc.), nickel oxide, chromium oxide, titanium, cerium, lanthanum, barium, zirconium, activated carbon, zeolite, etc. In some embodiments in which the reactive material is a solid, non-limiting examples of tritium-containing reaction products include tritiated water, tritiated ammonia, tritiated methane, tritium chloride, a metal hydride, etc. In some embodiments, a reactive solid may be capable of absorbing and/or binding tritium to active sites present on its surface.

Alternatively or additionally, the heat exchanger system may comprise a reactive coating on an external surface of the first conduit and/or the connector. The reactive coating may contain one or more reactive materials (e.g., a reactive solid described herein) capable of reacting with tritium to form one or more tritium-containing reaction products described elsewhere herein.

As described above, in some embodiments, the tritium from the primary fluid, when exiting from the external surface of the first conduit, may react with a reactive solid, reactive liquid, and/or reactive gas positioned external the first conduit to form one or more tritium-containing reaction products. The reactive solid, reactive liquid, and/or reactive gas may comprise any of a variety of solid, liquid, and/or gas described above and may be positioned in any appropriate location (e.g., as a coating on the first conduit and/or connector, contained within (a spacing containing) the sweep gas, etc.).

In some embodiments, the method comprises extracting the removed tritium from the sweep gas and/or a tritium-containing reaction product formed within the heat exchanger system. In some embodiments, the removed tritium and/or tritium-containing reaction product exiting the heat exchanger system may passed to a tritium extractor or separator. Tritium may be extracted via any of a variety of process, including, but not limited to, a temperature swing, a pressure swing, an electrolysis process, and/or an isotope separation process.

In some embodiments, the extracted tritium may be recycled into the fusion plant for subsequent use. For example, in some embodiments, the tritium may be subsequently recycled to the reactor as a reactant for carrying out additional fusion reactions (e.g., as illustrated above by eq. (1)).

As noted above, the heat exchanger system, in some embodiments, may include any of a variety of reactive materials positioned external the first conduit. For example, a reactive material may be present on a surface of a conduit (e.g., the first conduit or the second conduit), and/or be present in a sweep gas (if one is present).

The reactive material may, in some cases, be able to remove (e.g., react away) at least 50% (e.g., at least 55%, at least 60%, at least 70%, at least 80%, at least 85%, at least 90%, at least 92.5%, at least 95%, at least 97.5%, at least 99%, at least 99.5%, at least 99.9%, at least 99.95%, at least 99.99%, or all) of the tritium exiting (e.g., permeating through) an external surface of the first conduit and/or connector. As described elsewhere herein, non-limiting examples of a reactive material may include a reactive solid (e.g., CuO, etc.), a solid catalyst, a reactive liquid, a reactive gas (e.g., O₂, CO₂, N₂, etc.), a reactive coating, or combination thereof. In one set of embodiments, the heat exchanger system may comprise both a reactive material and a sweep gas. In another set of embodiments, the heat exchanger system comprise a reactive material but lack a sweep gas.

For example, in some embodiments, the heat exchanger system described herein may comprise a coating applied on one or more surfaces within the heat exchanger system. For example, the coating may advantageously reduce tritium permeation, mitigate corrosion of surfaces in contact with fluids, and/or capable of reacting with tritium. For example, in one set of embodiments, a tritium-resistant coating may be applied on an external surface of the second conduit, e.g., such that tritium may be prevented from permeating into the secondary fluid contained within the second conduit. Non-limiting examples of a tritium-resistant coating include tungsten, aluminum oxide, yttrium oxide, titanium nitride, boron nitride, aluminum nitride, silicon carbide, etc.

In some embodiments, as described elsewhere herein, a reactive coating may be applied on an external surface of a first conduit. The reactive coating may, in some cases, comprise a reactive solid capable of reacting with the tritium exiting the external surface of the first conduit to form a tritium-containing reaction product. Non-limiting examples of a reactive solid coating include CuO, iron oxide (e.g., hematite (Fe₂O₃), magnetite (Fe₃O₄), etc.), nickel oxide, chromium oxide, titanium, cerium, lanthanum, barium, zirconium, activated carbon, zeolite, etc. Alternatively or additionally, the reactive coating may comprise a catalyst capable of catalyzing a reaction between the exiting tritium and a reactive material described herein. Non-limiting examples of a catalyst that may be employed in the coating include a noble metal (e.g., palladium, platinum, silver, etc.) and/or metal oxides (e.g., CuO, NiO, Co₃O₄, MnO₂ etc.). The presence of one of more coatings described herein may advantageously assist with the removal of tritium exiting from the primary fluid, and prevent permeation of the exited tritium into the secondary fluid.

As noted above, the primary fluid within the heat exchanger system may be a fluid comprising tritium. In some embodiments, the primary fluid entering into an inlet of the first conduit may have a higher tritium concentration than the primary fluid exiting out of an outlet of the first conduit. For example, the presence of a sweep gas and/or a reactive material in the heat exchanger system may remove a substantial amount of tritium from the primary fluid entering into the first conduit, thereby producing an outlet primary fluid stream having a lower tritium concentration.

The primary fluid entering into the first conduit of the heat exchanger system may comprise any of a variety amount or concentration of tritium. In some embodiments, the primary fluid may comprise at least 10⁻⁶ mol/m³, at least 10⁻⁵ mol/m³, at least 10⁻⁴ mol/m³, at least 10⁻³ mol/m³, at least 10⁻² mol/m³, at least 10⁻¹ mol/m³, at least 1 mol/m³, or at least 5 mol/m³ of tritium. In some embodiments, the primary fluid may comprise up to 10⁻⁵ mol/m³, up to 10⁻⁴ mol/m³, up to 10⁻³ mol/m³, up to 10⁻² mol/m³, up to 10⁻¹ mol/m³, up to 1 mol/m³, up to 5 mol/m³, or up to 10 mol/m³ of tritium. Combination of the above-referenced range are possible (e.g., at least 10⁻⁶ mol/m³ of tritium (i.e., equivalent to a tritium activity of 0.03 Ci m⁻³) and up to 10 mol/m³ of tritium (i.e., equivalent to a tritium activity of 290,000 Ci m⁻³)). Other ranges are also possible.

In some embodiments, the primary fluid exiting the first conduit of the heat exchanger may comprise tritium at an amount (e.g., mol %) that is at least 50% (e.g., at least 60%, at least 70%, at least 80%, at least 85%, at least 90%, at least 92.5%, at least 95%, at least 97.5%, at least 99%, at least 99.5%, at least 99.9%, at least 99.95%, at least 99.99%, etc.) less than the concentration of tritium in the primary fluid entering the first conduit. In some instances, the primary fluid exiting the first conduit contains a negligible amount of tritium or does not contain tritium.

The primary fluid entering into the heat exchanger may have any of a variety of appropriate inlet temperatures. In some embodiments, the primary fluid entering into the heat exchanger may have an inlet temperature of greater than or equal to 600 K, greater than or equal to 650 K, greater than or equal to 700 K, greater than or equal to 750 K, greater than or equal to 800 K, greater than or equal to 850 K, greater than or equal to 900 K, or greater than or equal to 1000 K. In some embodiments, the primary fluid entering into the heat exchanger system may have an inlet temperature of less than or equal to 1200 K, less than or equal to 1100 K, less than or equal to 1000 K, less than or equal to 900 K, less than or equal to 850 K, less than or equal to 800 K, less than or equal to 750 K, less than or equal to 700 K, or less than or equal to 600 K. Combination of the above-referenced ranges are possible (e.g., greater than or equal to 600 K and less than or equal to 1200 K). Other ranges are also possible.

In some embodiment in which the heat exchanger is employed in a fusion power plant, the primary fluid comprises a lithium-containing materials. The lithium-containing material may be a tritium-breeding material. For example, the lithium-containing material may be capable of reacting with neutrons produced from the fusion reaction to produce additional tritium. e.g., see, eq. (2).

The lithium-containing materials may include, for example, a lithium-containing liquid metal, a lithium-containing liquid metal alloy, a lithium-containing molten salt, etc. Non-limiting examples of molten salt comprising lithium include FLiBe, FLiNaK, FLiNaBe, a LiF—PbF₂ mixture, etc. Non-limiting examples of liquid metals and metal alloys comprising lithium include Li, Pb—Li, etc.

Additionally or alternatively, in some embodiments in which the heat exchanger is employed in a fusion power plant, the lithium-containing materials may advantageously include a neutron multiplier material. Non-limiting examples of neutron multiplier materials include one or more of beryllium, lead, beryllium metal and alloy thereof, lead metal and alloy thereof, etc. Non-limiting examples of lithium-containing materials (e.g., molten salts and/or liquid metals) containing a neutron multiplier material include FLiBe, Pb—Li, FLiNaBe, a LiF—PbF₂ mixture, etc.

In some embodiment in which the heat exchanger is employed in a fission power plant, the primary fluid may include any of a variety of suitable materials. In some embodiments, the primary fluid may include a material having a particular set of thermal, hydraulic, and/or neutronic properties that is suitable for use in a heat exchanger employed for a fission power plant. In one embodiment, the primary fluid may comprise a lithium-containing material described elsewhere herein. In another set of embodiments, the primary fluid may comprise a non-lithium containing material. Non-limiting examples of materials employed in a primary fluid of a heat exchanger for a fission power plant include light water (e.g., comprising ¹H), heavy water (e.g., comprising ²H), FLiBe, FLiNaK, FLiNaBe, NaF—NaBF₄, KF—ZrF₄, etc.

In certain embodiments, the secondary fluid entering into a second conduit may comprise a negligible amount, if any, of tritium. According to certain embodiments, the secondary fluid entering into the second conduit may comprise no more than 10⁻⁷ mol/m³ (e.g., no more than 10⁻⁸ mol/m³, no more than 10⁻⁹ mol/m³, no more than 10⁻¹⁰ mol/m³, no more than 10⁻¹¹ mol/m³, no more than 10⁻¹² mol/m³, no more than 10⁻¹⁵ mol/m³, no more than 10⁻²⁰ mol/m³, etc.) of tritium. In some embodiments, the secondary fluid does not contain any tritium (e.g., tritium makes up 0 mol/m³ of the secondary fluid entering into the second conduit of a heat exchanger system).

The secondary fluid entering into the heat exchanger may have any of a variety of appropriate fluid temperatures. In some embodiments, the secondary fluid entering into the heat exchanger may have a temperature of greater than or equal to 300 K, greater than or equal to 400 K, greater than or equal to 500 K, greater than or equal to 600 K, greater than or equal to 700 K, greater than or equal to 800 K, or greater than or equal to 850 K. In some embodiments, the secondary fluid entering into the heat exchanger system may have a temperature of less than or equal to 900 K, less than or equal to 850 K, less than or equal to 800 K, less than or equal to 700 K, less than or equal to 600 K, less than or equal to 500 K, or less than or equal to 400 K. Combination of the above-referenced ranges are possible (e.g., greater than or equal to 300 K and less than or equal to 900 K). Other ranges are also possible.

In some embodiments, the secondary fluid exiting the second conduit of the heat exchanger may comprise a relatively low amount (or negligible amount) of tritium. The heat exchanger system described herein may advantageously prevent tritium in the primary fluid from leaking into the secondary fluid. In some embodiments, the secondary fluid exiting the second conduit may comprise no more than 10⁻⁷ mol/m³ (e.g., no more than 10⁻⁸ mol/m³, no more than 10⁻⁹ mol/m³, no more than 10⁻¹⁰ mol/m³, no more than 10⁻¹¹ mol/m³, no more than 10⁻¹² mol/m³, no more than 10⁻¹⁵ mol/m³, no more than 10⁻²⁰ mol/m³, etc.) of tritium. In some embodiments, the secondary fluid does not contain any tritium (e.g., tritium makes up 0 mol/m³ of the secondary fluid exiting the second conduit of a heat exchanger system).

The secondary fluid may comprise any of a variety of suitable process fluids described herein. In some embodiments, the secondary fluid may comprise a power cycle fluid and/or a molten salt. Non-limiting examples of a secondary fluid are described elsewhere herein.

In some embodiments, the method comprises passing a primary fluid comprising tritium into a first conduit of a heat exchanger system. As described in more detail below, the primary fluid comprising tritium may be a high-temperature reactor fluid passed into the first conduit from (a part of) a fusion reactor (e.g., such as from a tritium breeding blanket).

For example, referring back to FIGS. 1A-6D, in a heat exchanger system (e.g., system 10, 30, 50, 60, 70, 80), a primary fluid (e.g., fluid 13) containing tritium may be passed into a first conduit (e.g., first conduit 12, 32, 52, 62, 72, 82).

In some embodiments, the method comprises passing a secondary fluid into a second conduit of a heat exchanger system. For example, referring back to FIGS. 1A-6D, in a heat exchanger system (e.g., system 10, 30, 50, 60, 70, 80), a secondary fluid (e.g., fluid 15) may be passed into a second conduit (e.g., conduit 14, 34, 54, 64, 74, 84). The secondary fluid entering into the second conduit may have a temperature lower than that of the primary fluid entering into the first conduit and may comprise any of a variety process fluids described elsewhere herein.

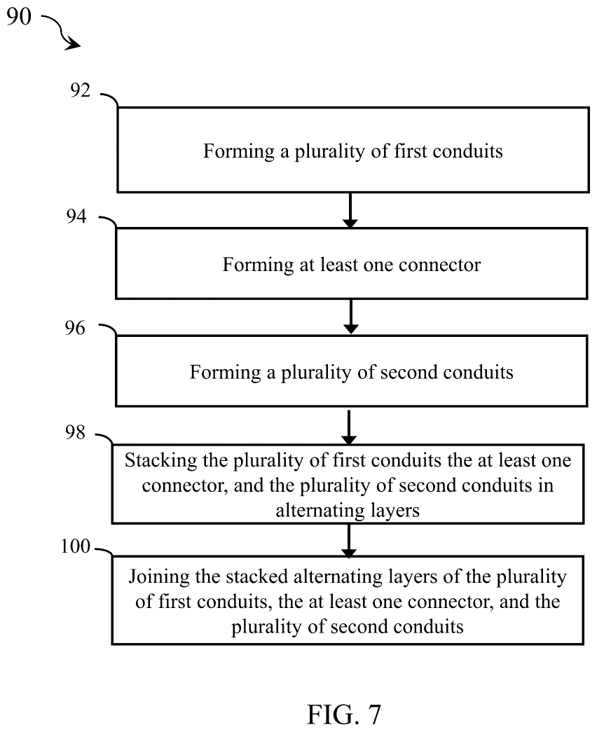

The first conduit and/or second conduit may have any appropriate cross-sectional shape and configuration. For example, the first conduit may comprise pipes, e.g., such as the first conduits 12, 32, 62, 82 shown in FIGS. 1A-1C, 2-4, and 6. In another example, the first conduits may comprise channels formed within one or more sheets of metal, e.g., such as the first conduits 52 and 72 in FIGS. 5 and 7. The second conduit may, in some case, have a cross-sectional shape and configuration that is the same as or different from the first conduit.

The first conduit and/or the second conduit may be formed from any appropriate metal and/or metal alloy. In some embodiments, the metal and/or metal alloy comprises a creep-resistance alloy capable of withstanding stress (e.g., a pressure exerted by the fluid contained within the conduits). Non-limiting examples of a metal and/or metal alloy include nickel, copper, iron, chromium, cobalt, molybdenum, or alloys thereof. Non-limiting examples of alloys include Hastelloy N, Inconel 600, Inconel 617, Inconel 625, AISI 316L stainless steel, Monel, etc.

The first conduit and/or second conduit may have any appropriate dimensions. For example, in some embodiments, the first conduit and/or the second conduit may have a cross-sectional dimension of at least 0.1 mm, at least 1 mm, at least 5 mm, at least 10 mm, at least 20 mm, at least 40 mm, at least 60 mm, or at least 80 mm. In some embodiments, the first conduit and/or the second conduit may have a cross-sectional dimension of no more than 100 mm, no more than 80 mm, no more than 60 mm, no more than 40 mm, no more than 20 mm, no more than 10 mm, no more than 5 mm, or no more than 1 mm. Combinations of the above-referenced ranges are possible (e.g., at least 0.1 mm and no more than 100 mm). Other ranges are also possible. In some embodiments, the cross-sectional dimension of the first conduit and the cross-sectional dimension of the second conduit may be the same or different.

The heat exchanger described herein may comprise any suitable number of first conduits and/or second conduits. For example, in some embodiments, the heat exchanger may comprise at least 1, at least 2, at least 5, at least 10, at least 50, at least 100, at least 500, at least 1,000, at least 5,000, at least 10,000, at least 50,000, at least 100,000, or at least 500,000 first conduits and/or second conduits. In some embodiments, the heat exchanger may comprise no more than 1,000,000, no more than 500,000, no more than 100,000, no more than 50,000, no more than 10,000, no more than 5,000, no more than 1,000, no more than 500, no more than 100, no more than 50, no more than 10, or no more than 5, or no more than 2 first conduits and/or second conduits. Combinations of the above-referenced ranges are possible (e.g., at least 1 and no more than 1,000,000). Other ranges are also possible. In some embodiments, the number of first conduits and the number of second conduits present in the heat exchanger may be the same or different.

The heat exchanger described herein may have any of a variety of additional components. In some embodiments, one or more pumps may be employed in the heat exchanger system for circulating the primary fluid and/or secondary fluid. The heat exchanger system may further comprise control systems for regulating various conditions (e.g., temperature, pressure, flow rate, etc.) of various fluids (e.g., primary fluid, secondary fluid, sweep gas, etc.) within the system. In some cases, automated leak detection systems for detecting leaks of various fluids (e.g., primary fluid, secondary fluid, sweep gas) and/or tritium may be implemented throughout the heat exchanger system.

In some embodiments, a heat exchanger system for applications in a fusion power plant is described herein. In one set of embodiments, the heat exchanger system comprises a first conduit and a second conduit thermally coupled to the first conduit. The conduit may be any structure containing a fluidic pathway for fluid flow, and may be open or closed. In some cases, a conduit may have a cross-sectional dimension that is smaller than its longitudinal (i.e., axial) dimension. A non-limiting example of the heat exchanger system described herein is shown in FIGS. 1A-1C. As shown, a heat exchanger system 10 may comprise a first conduit 12 and a second conduit 14 thermally coupled to the first conduit 12. The first conduit 12 and second conduit 14 may each include a respective conduit wall 12B and 14B. As described in more detail below, the first conduit and/or second conduit may have any of a variety of configurations, including, but not limited to, a pipe, a channel, etc.

While FIGS. 1A-1C show one embodiment in which the first conduit and second conduit each comprises a circular shaped cross-section, it should be noted that not all embodiments described herein are so limiting, and in other embodiments, the first conduit and/or second conduit may comprise a cross-section having any appropriate shapes, e.g., a square, a rectangle, a triangle, a polygon, an ellipse, etc.

In some embodiments, the first conduit and the second conduit are thermally coupled to each other via a connector, which may be a solid material. For example, in one embodiment, the heat exchanger system comprises a connector thermally coupling an external surface of the first conduit to an external surface of the second conduit. In some embodiments, an external surface of a conduit may be an outermost surface of the conduit, e.g., such as a surface that is exposed to the environment surrounding the conduit.

A non-limiting example of one such embodiment is illustrated in FIGS. 1A-1C. As shown, for example, the first conduit 12 may include a conduit wall 12B having external surface 12A. Similarly, the second conduit 14 may include a conduit wall 14B having an external surface 14A. The heat exchanger system 10 may comprise a connector 16 thermally coupling the external surface 12A of the first conduit 12 to the external surface 14A of the second conduit 14. As shown, the external surfaces 12A and 14A may be the outermost surfaces of the first and second conduits 12 and 14.

While FIGS. 1A-1C show one embodiment in which the first conduit and second conduit each comprises a single conduit wall, it should be noted that not all embodiments described herein are so limiting, and in other embodiments, the first conduit and/or second conduit may comprise more than one conduit wall, e.g., such as a double wall pipe with an inner wall and an outer wall concentric to the inner wall. In some embodiments, a connector may be configured to thermally couple an external surface (e.g., outermost surface of the outer wall) of the first conduit to an external surface (e.g., outermost surface of the outer wall) of the second conduit.

In some embodiments, the connector thermally coupling the first conduit and the second conduit is a solid connector. Thus, the connector may be formed from a solid piece of material. In some cases, the solid material may not have any internal cavities (i.e., that are not exposed to the environment surrounding the material) and/or fluidic pathways (e.g., channels, conduits) disposed therein. For example, as shown in FIG. 1B, the connector 16 is a solid connector without any internal cavities or fluidic pathways within the material. In some cases, a solid connector does not include a pipe, a channel, or the like.

In some embodiments, the heat exchanger system comprises a gas flow device. The gas flow device, in some cases, may be positioned to flow a gas (i.e., a sweep gas) around the first conduit, the second conduit, and the connector (e.g., a solid connector). Non-limiting examples of a gas flow device may include a pump, a fan, etc. For example, referring back to FIGS. 1A-1B, the heat exchanger system 10 may comprise a gas flow device 18 positioned to flow a gas 20 around the first conduit 12, the second conduit 14, and the connector 16. The gas flow device may be placed in any appropriate positions in the heat exchanger system, e.g., as long as the gas may be flowed across a substantial portion (e.g., at least 50%, at least 60%, at least 70%, at least 80%, at least 90%, at least 95%, or all) of the external surfaces of the first conduit, second conduit, and the connector. In some cases, the gas flow device may be positioned such that a sweep gas (e.g., sweep gas 20 in FIG. 1A) having a flow direction substantially parallel to the longitudinal dimension of the first and/or second conduit is produced, e.g., as shown in FIG. 1A. In addition, in some cases, more than one gas flow device may be present.

In some embodiments, the heat exchanger system may be configured and operated to allow for efficient heat transfer from a tritium-containing primary fluid to a secondary fluid. The first conduit, in some embodiments, may be configured to contain a primary fluid comprising tritium. The tritium may arise, for example, from reactions between lithium in the fluid and neutrons from fusion reactions, e.g., as shown in eq. (1) and eq. (2) described above. The second conduit, in some embodiments, may be configured to contain a secondary fluid. Referring again to FIGS. 1A-1B, as a non-limiting example, the first conduit 12 may contain a primary fluid 13 comprising tritium and the second conduit 14 may contain a secondary fluid 15.

In some embodiments, the primary fluid is a tritium-containing fluid having an elevated influent temperature (e.g., the “hot” stream). For example, the primary fluid may be a tritium-containing high-temperature fluid from a fusion reactor, e.g., such as a molten salt and/or a liquid metal comprising tritium. In some embodiments, the secondary fluid (e.g., the “cold” stream) has a lower influent temperature compared to the primary fluid. Heat is thus transferred from the primary or “hot” stream to the secondary or “cold” stream via the heat exchanger. The secondary fluid may be any of a variety of suitable process fluids described herein. The secondary fluid, in certain embodiments, may comprise tritium at a lower concentration than the primary fluid. In some instances, the secondary fluid may contain a negligible amount, if any, of tritium. Non-limiting examples of process fluids include a power cycle fluid and/or a molten salt. Non-limiting examples of a power cycle fluid include water, carbon dioxide, helium, air, etc. Non-limiting examples of a molten salt that can be employed as the process fluid include various nitrate salts, e.g., such as NaNO₃, KNO₃, NaNO₂, etc.

In some embodiments, the connector thermally coupling the first conduit and second conduit may be configured to conduct heat from the primary fluid contained within the first conduit to the secondary fluid contained within the second conduit. For example, as shown in FIGS. 1B-1C, the connector 16 may be configured to conduct heat 17 from the primary fluid 13 (e.g., a hot stream) within the first conduit 12 to the secondary fluid 15 (e.g., a cold stream) within the second conduit 14. Heat from the primary fluid 13 may be conducted through the conduit wall 12B of the first conduit 12, through the connector 16, and subsequently through the conduit wall 14B of the second conduit 14 into the secondary fluid 15.

The presence of a connector (e.g., a solid connector), in some cases, may allow for efficient heat transfer from the primary fluid to the secondary fluid, while minimizing permeation of tritium from the first fluid into the secondary fluid. Referring to FIG. 1C, for example, the connector may be configured so as to minimize permeation of tritium from the first fluid 13 into the secondary fluid 15, as discussed herein.

In certain embodiments, the heat exchanger system may comprise a sweep gas surrounding the first conduit, the second conduit, and the connector (e.g., a solid connector). For example, as shown in FIGS. 1A-1C, the heat exchanger system 10 may comprise a sweep gas 20 surrounding the first conduit 12, the second conduit 14, and the solid connector 16. The sweep gas, according to some embodiments, may advantageously facilitate removal (e.g., via arrow 19 in FIG. 1C) of tritium from the primary fluid exiting an external surface of the first conduit and/or connector into the sweep gas, e.g., such that the amount of tritium available to permeate through the connector into the secondary fluid is reduced. That is, the sweep gas may serve as a sink for tritium such that a negligible amount, if any, of tritium may be capable of permeating into the secondary fluid, e.g., via diffusion through the connector and/or re-entry from the surrounding environment. In some embodiments, the sweep gas is configured to contain a portion of tritium arising from the primary fluid. For example, as shown in FIG. 1C, the sweep gas 20 may contain tritium arising from the primary fluid 13, and may prevent or inhibit the tritium from reaching the primary fluid 13.

In particular, as described in more detail herein, the sweep gas may be capable of removing the tritium from the first fluid via any of a variety of suitable routes, e.g., such as via physical transfer (e.g., convective mass transfer) and/or chemical reaction (e.g., reacting tritium with a reactive material into a tritium-containing reaction product).

In some embodiments, the heat exchanger system comprises a reactive material (e.g., a reactive gas, liquid, and/or solid) positioned externally of the first conduit and the second conduit. For example, the reactive material may be contained within the sweep gas. In some cases, the reactive material may be capable of reacting or chemically binding the tritium. In some cases, the tritium-containing reaction product may have a lower diffusivity than tritium. For example, referring again to FIGS. 1A-1C, the heat exchanger system 10 may comprise a reactive material (not shown) positioned externally of the first conduit 12, second conduit 14 and/or the connector 16.

In some embodiments, the reactive material includes a reactive gas capable of reacting or chemically binding with tritium. In some cases, the reactive gas may be (a part of) the sweep gas or the reactive gas may be itself the sweep gas, e.g., a reactive sweep gas. For example, referring again to FIGS. 1A-1C, the reactive material (not shown) may a reactive gas that is (a part of) the sweep gas 20. Alternatively or additionally, in some embodiments, the reactive material may be a reactive solid or reactive liquid disposed within the space containing and/or adjacent the sweep gas, e.g., contained by the sweep gas. Alternatively or additionally, in some embodiments, the reactive material may be disposed in the form of a reactive material coating disposed on the external surface of the first conduit, the second conduit, and/or the connector. For example, referring again to FIGS. 1A-1C, the reactive material (not shown) may be in the form of a reactive solid or liquid disposed in a space containing and/or adjacent the sweep gas 20. As another example, the reactive material may be disposed in the form of a reactive material coating disposed on an external surface around the first conduit 12, the second conduit 14, and/or the connector 16.

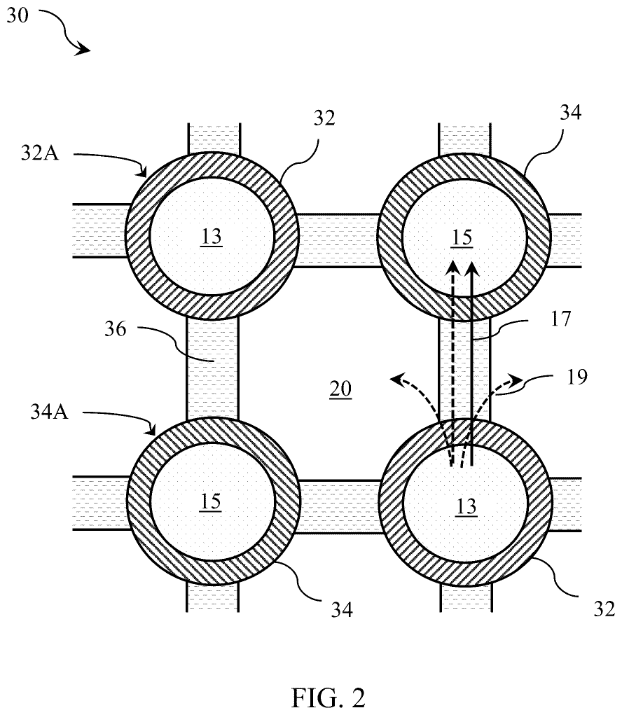

While FIGS. 1A-1C show one embodiment in which the heat exchanger system comprises a first conduit and a second conduit thermally coupled by a connector, it should be noted that not all embodiments described herein are so limited, and in other embodiments, the heat exchanger system may comprise a plurality of first and/or second conduits coupled by at least one connector. For example, various embodiments of such a heat exchanger system are illustrated in FIGS. 2-6D, as described in more detail below.

In one set of embodiments, the heat exchanger system comprises a plurality of first conduits and a plurality of second conduits thermally coupled to the plurality of first conduits. FIG. 2 provides a non-limiting embodiment of such a heat exchanger system. As shown in FIG. 2, the heat exchanger system 30 comprises a plurality of first conduits 32 and a plurality of second conduits 34 thermally coupled to the plurality of first conduits 32. In some embodiments, at least one of the plurality of first conduits is thermally coupled to two or more (e.g., at least 3, at least 4, at least 5, etc.) of the plurality of second conduits. Alternatively or additionally, at least one of the plurality of second conduits is thermally coupled to two or more (e.g., at least 3, at least 4, at least 5, etc.) of the plurality of first conduits. For example, as shown in FIG. 2, at least one of the plurality of first conduits 32 is thermally coupled to two or more of the plurality of second conduits 34. Similarly, at least one of the plurality of second conduits 34 is thermally coupled to two or more of the plurality of first conduits 32.

In some embodiments, the plurality of first conduits and the plurality of secondary conduits are arranged in an alternating configuration with respect to each other. Referring again to FIG. 2 as a non-limiting example, the plurality of first conduits 32 and the plurality of secondary conduits 34 are arranged in this example in an alternating configuration with respect to each other, e.g., such as arranged in a lattice array. In some cases, the first and second conduits may be present in an alternating arrangement.

The plurality of first conduits, in some embodiments, may be thermally coupled to the plurality of second conduits via one or more connectors. In some cases, the connector may be a solid connector. The connector may, in some cases, couple an external surface of at least one of the plurality of first conduits to the external surfaces of at least two or more of the plurality of second conduits. For example, as shown in FIG. 2, an external surface 32A of at least one of plurality of first conduits 32 may be thermally coupled by a connector 36 (e.g., a solid connector) to the external surfaces 34A of two or more of the plurality of second conduits 34. Alternatively or additionally, an external surface of the at least one of the plurality of second conduits may be thermally coupled to the external surfaces of two or more of the plurality of first conduits. As shown in FIG. 2, for example, an external surface 34A of at least one of plurality of second conduits 34 may be thermally coupled by a connector 36 (e.g., a solid connector) to the external surfaces 32A of two or more of the plurality of first conduits 32.

The plurality of first conduits and second conduits may have any of a variety of properties described elsewhere herein. For example, at least some of the plurality of first conduits may be configured to contain a primary fluid (e.g., a hot stream) comprising tritium, e.g., as shown by primary fluid 13 in FIG. 2. Additionally, in some embodiments, at least some of the plurality of second conduits may be configured to contain a secondary fluid (e.g., a cold stream) containing a small amount, if any, of tritium, e.g., as shown by secondary fluid 15 in FIG. 2.

In some embodiments, the connector thermally coupling the first conduit and second conduit may be configured to conduct heat from the primary fluid contained within the first conduit to the secondary fluid contained within the second conduit. For example, as shown in FIG. 2, the connector 36 may be configured to conduct heat 17 from the primary fluid 13 (e.g., a hot stream) within the first conduit 12 to the secondary fluid 15 (e.g., a cold stream) within the second conduit 15.

In some embodiments, the heat exchanger system comprises a sweep gas surrounding the plurality of first conduits, the plurality of second conduits and/or the at least one connector. For example, as shown in FIG. 2, the heat exchanger system may comprise a sweep gas 20 surrounding the plurality of first conduits 32, the plurality of second conduits 34, and/or the at least one connector 36. The sweep gas may have any property described previously. For example, in FIG. 2, the sweep gas may facilitate removal of tritium (e.g., via arrow 19) from the primary fluid 13 and/or any tritium permeated into the connector 36 into the sweep gas 20. As such, the sweep gas 20 may contain tritium arising from the primary fluid 13. Accordingly, in the presence of the sweep gas, the amount of tritium available to permeate through the connector into the secondary fluid may be reduced.

The heat exchanger system described in FIG. 2 may have any of a variety of additional components and properties described previously, including a gas flow device, a reactive material, etc. It should also be noted that the heat exchanger system describe in FIG. 2 may comprise any appropriate number of first conduits and second conduits. For the sake of illustration, FIG. 2 shows a single lattice array of first conduits and second conduits. However, it should be noted that the heat exchanger system may include any suitable number of the lattice array illustrated in FIG. 2, where at some of the lattice arrays are thermally coupled to each other via the connectors described herein.

While FIG. 2 illustrates one embodiments of a heat exchanger system comprising a plurality of first conduits and a plurality of second conduits arranged and constructed in a particular configuration, it should be noted that not all embodiments described herein are so limiting, and in other embodiments, the heat exchanger system may comprise a plurality of the first and second conduits arranged and constructed in any of a variety of appropriate configurations described herein.

For example, FIG. 3 illustrates a second embodiment of a heat exchanger system comprising a plurality of first conduits and a plurality of second conduits thermally coupled to the plurality of first conduits. As shown, the heat exchanger system 50 comprises a plurality of first conduits 52 and a plurality of second conduits 54 thermally coupled to the plurality of first conduits 52. In some embodiments, the plurality of first conduits comprises conduits formed within one or more sheets of metal or metal alloy. For example, as shown in FIG. 3, the plurality of first conduits 52 comprises conduits formed within one or more sheets, e.g., such as two sheets 53A and 53B, of metal and/or metal alloy.

In some embodiments, at least one of the plurality of first conduits is thermally coupled to two or more (e.g., at least 3, at least 4, at least 5, etc.) of the plurality of second conduits. For example, as shown in FIG. 3, at least one of the plurality of first conduits 52 is thermally coupled to two or more of the plurality of second conduits 54. Alternatively or additionally, at least one of the plurality of second conduits is thermally coupled to two or more (e.g., at least 3, at least 4, at least 5, etc.) of the plurality of first conduits. For example, as shown in FIG. 3, at least one of the plurality of second conduits 54 is thermally coupled to two or more of the plurality of first conduits 52.

Similar to the heat exchanger system described in FIG. 2, the heat exchanger system 50 of FIG. 3 may comprise a plurality of first conduits thermally coupled to the plurality of second conduits via at least one connector (e.g., a solid connector). For example, as shown in FIG. 3, the heat exchanger system 50 comprises a connector 56. An external surface 52A of at least one of the plurality of first conduits 52 may be thermally coupled by the connector 56 (e.g., a solid connector) to the external surfaces 54A of two or more of the plurality of second conduits 54. Similarly, an external surface 54A of at least one of plurality of second conduits 54 may be thermally coupled by the connector 56 (e.g., a solid connector) to the external surfaces 52A of two or more of the plurality of first conduits 52. In some embodiments, the at least one connector may be in the form of one or more corrugated sheet, e.g., as shown in FIG. 3.

In some embodiments, the plurality of first conduits, the at least one solid connector, and the plurality of second conduits are arranged in alternating layers. Referring again to FIG. 3 as a non-limiting example, the plurality of first conduits 52, the at least one solid connector 56, and the plurality of secondary conduits 54 may be arranged in alternating layers with respect to each other. For example, the heat exchanger system 50 may comprise a plurality of layers alternating between a layer of first conduits 52 and a layer of second conduits 54, with a layer of the at least one connector 50 positioned between each layer of first conduits 52 and each layer of second conduits 54. It should also be noted that the heat exchanger system describe in FIG. 3 may comprise any appropriate number of alternating layers of first conduits, solid connectors, and second conduits.

The plurality of first conduits and second conduits may have any of a variety of properties described with respect to FIGS. 1A-2. For example, at least some of the plurality of first conduits may be configured to contain a primary fluid (e.g., a hot stream) comprising tritium, e.g., as shown by the primary fluid 13 in FIG. 3. Additionally, in some embodiments, at least some of the plurality of second conduits may be configured to contain a secondary fluid (e.g., a cold stream) containing a negligible amount, if any, of tritium, e.g., as shown by the secondary fluid 15 in FIG. 3. In some embodiments, the connectors 56 thermally coupling the plurality of first conduits 52 and the plurality of second conduits 54 may be configured to conduct heat from the primary fluid 13 contained within the first conduit 52 to the secondary fluid 15 contained within the second conduit 54. For example, as shown in FIG. 3, the connector 56 may be configured to conduct heat 17 from the primary fluid 13 (e.g., a hot stream) within the first conduit 12 to the secondary fluid 15 (e.g., a cold stream) within the second conduit 15.

According to some embodiments, as shown in FIG. 3, the heat exchanger system 50 further comprises a sweep gas 20 surrounding the plurality of first conduits 52 and the plurality of second conduits 54. The sweep gas may have any property described previously, e.g., with respect to FIGS. 1A-2. For example, the sweep gas may facilitate removal of tritium (e.g., via arrow 19 in FIG. 3) from the primary fluid 13 and/or any tritium permeated into the connector 56 into the sweep gas 20. As such, the sweep gas 20 may contain tritium arising from the primary fluid 13. In the presence of the sweep gas, the amount of tritium available from the primary fluid for permeating through the connector into the secondary fluid may be reduced.

The heat exchanger system described in FIG. 3 may have any of a variety of additional components and properties described previously, including a gas flow device, a reactive material, etc.

FIG. 4 illustrates another embodiment of a heat exchanger system comprising a plurality of first conduits and a plurality of second conduits thermally coupled to the plurality of first conduits. As shown, the heat exchanger system 60 comprises a plurality of first conduits 62 and a plurality of second conduits 64 thermally coupled to the plurality of first conduits 62. According to some embodiments, at least one of the plurality of first conduits 62 is thermally coupled to two or more of the plurality of second conduits 64. Similarly, at least one of the plurality of second conduits 64 may be thermally coupled to two or more of the plurality of first conduits 62.

Similar to the heat exchanger systems described in FIGS. 2-3, the heat exchanger system 60 of FIG. 4 may comprise a plurality of first conduits thermally coupled to the plurality of second conduits via at least one connector (e.g., a solid connector). For example, as shown in FIG. 4, the heat exchanger system 60 comprises a connector 66 positioned between the plurality of first conduit 62 and the plurality of second conduits 64. An external surface 62A of at least one of the plurality of first conduits 62 may be thermally coupled by the connector 66 (e.g., a solid connector) to the external surfaces 64A of two or more of the plurality of second conduits 64. Similarly, an external surface 64A of at least one of plurality of second conduits 64 may be thermally coupled by the connector 66 (e.g., a solid connector) to the external surfaces 62A of two or more of the plurality of first conduits 62.

In some embodiments, the at least one connector may be in the form of single corrugated sheet, e.g., as shown in FIG. 4. In some embodiments, the plurality of first conduits and/or the plurality of second conduits may be bonded to (e.g., soldered, welded, brazed, etc.) to the corrugated connector via an intermediate brazing material, e.g., a metal. For example, as shown in FIG. 4, the plurality of first conduits 62 and/or the plurality of second conduits 64 may be bonded (e.g., welded, brazed, etc.) to the at least connector via an intermediate brazing material 65.

According to some embodiments, as shown in FIG. 4, the plurality of first conduits 62, the at least one solid connector 66, and the plurality of secondary conduits 64 may be arranged in alternating layers with respect to each other. For example, the heat exchanger system 60 may comprise a plurality of layers alternating between a layer of first conduits 62 and a layer of second conduits 64, with a layer of the at least one connector 60 positioned between each layer of first conduits 62 and each layer of second conduits 64. It should also be noted that the heat exchanger system describe in FIG. 4 may comprise any appropriate number of alternating layers of first conduits, solid connectors, and second conduits.

According to some embodiments, as shown in FIG. 4, the heat exchanger system 60 further comprises a sweep gas 20 surrounding the plurality of first conduits 62 and the plurality of second conduits 64. The sweep gas may have any property described previously, e.g., with respect to FIGS. 1A-3. For example, the sweep gas may facilitate removal of tritium (e.g., via arrow 19 in FIG. 3) from the primary fluid 13 and/or any tritium permeated into the connector 66 into the sweep gas 20. As such, the sweep gas 20 may contain tritium arising from the primary fluid 13. Accordingly, in the presence of the sweep gas, the amount of tritium available from the primary fluid for permeating through the connector into the secondary fluid may be reduced.

The heat exchanger system described in FIG. 4 may have any of a variety of additional components and properties described previously, including a gas flow device, a reactive material, etc.

FIG. 5 illustrates yet another embodiment of a heat exchanger system comprising a plurality of first conduits and a plurality of second conduits thermally coupled to a plurality of first conduits. As shown, the heat exchanger system 70 comprises a plurality of first conduits 72 and a plurality of second conduits 74 thermally coupled to the plurality of first conduits 72. According to some embodiments, at least one of the plurality of first conduits 72 may be thermally coupled to two or more of the plurality of second conduits 74. Similarly, at least one of the plurality of second conduits 74 may be thermally coupled to two or more of the plurality of first conduits 72.

Similar to the heat exchanger systems described in FIGS. 1A-4, the heat exchanger system 70 of FIG. 5 may comprise a plurality of first conduits thermally coupled to the plurality of second conduits via at least one connector (e.g., a solid connector). For example, as shown in FIG. 5, the heat exchanger system 70 may comprise a connector 76 positioned between the plurality of first conduits 72 and the plurality of second conduits 74. An external surface 72A of at least one of the plurality of first conduits 72 may be thermally coupled by the connector 76 (e.g., a solid connector) to the external surfaces 74A of two or more of the plurality of second conduits 74. Similarly, an external surface 74A of at least one of plurality of second conduits 74 may be thermally coupled by the connector 66 (e.g., a solid connector) to the external surfaces 72A of two or more of the plurality of first conduits 72.

In some embodiments, the plurality of first conduits and/or the plurality of second conduits may be formed from corrugated sheets of metal and/or metal alloy. For example, as shown in FIG. 5, each of the plurality of first conduits 72 and the plurality of second conduits 74 may be formed from two sheets of metal and/or metal alloy, e.g., 73A and 73B.

According to some embodiments, as shown in FIG. 4, the plurality of first conduits 72, the at least one solid connector 76, and the plurality of secondary conduits 74 may be arranged in alternating layers with respect to each other. For example, the heat exchanger system 70 may comprise a plurality of layers alternating between a layer of first conduits 72 and a layer of second conduits 74, with a layer of the at least one connector 70 positioned between each layer of first conduits 72 and each layer of second conduits 74. It should also be noted that the heat exchanger system describe in FIG. 5 may comprise any appropriate number of alternating layers of first conduits, solid connectors, and second conduits.

The plurality of first conduits, second conduits, and connectors described with respect to FIGS. 4-5 and may have any of a variety of properties described herein. For example, at least some of the plurality of first conduits may be configured to contain a primary fluid (e.g., a hot stream) comprising tritium, e.g., primary fluid 13. Additionally, in some embodiments, at least some of the plurality of second conduits may be configured to contain a second fluid (e.g., a cold stream) containing a small amount, if any, of tritium, e.g., secondary fluid 15. The connector may be configured to conduct heat 17 from the primary fluid 13 (e.g., the hot stream) within the plurality of first conduit to the secondary fluid 15 (e.g., the cold stream) within the plurality of second conduit.

The heat exchanger system described in FIG. 4-6 may have any of a variety of additional components and properties described previously, e.g., including a gas flow device, a sweep gas, a reactive material, etc. For example, the heat exchanger systems described in FIGS. 4-6 may also comprise a sweep gas 20 surrounding the plurality of first conduits and the plurality of second conduits. The sweep gas may have any property described previously, e.g., with respect to FIGS. 1-3. For example, the sweep gas may facilitate removal of tritium 19 from the primary fluid 13 and/or any tritium permeated into the connector into the sweep gas 20. As such, the sweep gas 20 may contain tritium arising from the primary fluid 13. Accordingly, in the presence of the sweep gas may advantageously reduce the amount of tritium available to permeate through the connector into the secondary fluid.

While FIGS. 2-5 show various embodiments of a heat exchanger system comprising a plurality of first conduits and a plurality of second conduits arranged in an alternating configuration, it should be noted that not all embodiments described herein are so limiting, and in other embodiments, the first and second conduits in a heat exchanger may be arranged in other configurations, e.g., such as a coiled or wound configuration. FIGS. 6A-6D shows a non-limiting embodiment of a heat exchanger system having a coiled configuration.

FIG. 6A is a schematic representation of a cross-section of a single heat exchanger unit 80A that can be used to form a heat exchanger system having a coiled configuration. As shown in FIG. 6A, the heat exchanger unit comprises a first conduit 82 and a second conduit 84 thermally coupled to the first conduit 82. Similar to the heat exchanger systems described in FIGS. 1A-5, the heat exchanger unit may comprise a connector 86 (e.g., a solid connector) configured to thermally couple the first conduit 82 to the second conduit 84. In some cases, the connector 86 may thermally couple an external surface 82A of the first conduit 82 to an external surface 84A of the second conduit 84. In some instances, as shown in FIG. 6A, the first conduit 82 and/or the second conduit 84 may be bonded (e.g., welded, brazed, etc.) to the connector 86 via an intermediate brazing material 85.

In some embodiments, the first conduit and the second conduit may be positioned on the same side of the connector (e.g., a solid connector). For example, as shown in FIG. 6A, in the heat exchanger unit 80A, the first conduit 82 and the second conduit 84 may be positioned on (e.g., attached to) a first side of the connector 86.

The first conduit 82 may be configured to contain a primary fluid 13 comprising a tritium and the second conduit 84 may be contain a secondary fluid 15. According to some embodiments, the connector 86 may be configured to conduct heat 17 from the primary fluid 13 contained within the first conduit 82 to the second secondary fluid 15 contained within the second conduit 84, e.g., as shown by flow arrow 17.

In some embodiments, the heat exchanger unit may further comprise an insulating layer adjacent the connector. For example, as shown in FIG. 6A, the heat exchanger unit may further comprise an insulating layer 88 positioned adjacent the connector 86 at a side opposite the first conduit 82 and the second conduit 84. The insulating layer may, in some cases, prevent transferring of heat from the connector 86 into a region positioned beneath the insulating layer 88 at a side opposite the connector 86.

In some embodiments, a heat exchanger unit (e.g., heat exchanger unit 80A in FIG. 6A) may be wound or rolled to form a coiled heat exchanger unit. For example, as shown in FIGS. 6A-6B, the heat exchanger unit 80A of FIG. 6A may be wound or rolled about a center axis to form a heat exchanger unit 80B having a coiled configuration (e.g., such as a cylindrical heat exchanger unit). FIG. 6B illustrates a cross-section of a portion of a heat exchanger unit 80B having a coiled configuration. As shown, the cross-section of the coiled heat exchanger unit 80B comprises repetitive units of the heat exchanger unit 80A. A side view of the coiled heat exchanger unit 80B is also illustrated in FIG. 6C. For example, as shown in FIG. 6C, the coiled heat exchanger unit 80B may comprise a first conduit inlet 82C for feeding a primary fluid, a first conduit outlet 82D for outputting the primary fluid, a second conduit inlet 84C for feeding a secondary fluid, and a second conduit outlet 84D for outputting the secondary fluid.

In some embodiments, a heat exchanger system may comprise a plurality of coiled heat exchanger units. A top down view of a non-limiting example of such a heat exchanger system is shown in FIG. 6D. For example, as shown in FIG. 6D, a heat exchanger system 80C may comprise a plurality of the coiled heat exchanger units 80B illustrated in FIG. 6C. The plurality of heat exchanger units may, in certain embodiments, be connected to a manifold to form a heat exchanger system. For example, as described in more detail below, a manifold may be configured to arrange the first conduits and/or second conduits from various coiled heat exchanger units into a single inlet pipe and a single outlet pipe for each type of fluid described herein (e.g., a primary fluid, a secondary fluid).

FIG. 6D illustrates a non-limiting example of a manifold that may be employed in the heat exchanger system 80C. For example, in FIG. 6D, the heat exchanger system 80C may comprise a manifold 89. The manifold 89 may comprise a plurality of pipes, e.g., including a primary fluid inlet pipe 113A, a primary fluid outlet pipe 113B, a secondary fluid inlet pipe 115A, and a secondary fluid outlet pipe 115B. The inlet and outlet pipes may be fluidically connected to various inlets and outlets of the first and second conduits from each of the plurality of coiled heat exchanger units 80B. For example, as shown in FIGS. 6C-6D, the primary fluid inlet pipe 113A may be fluidically connected to the first conduit inlet 82C on the heat exchanger unit 80B, the secondary fluid inlet pipe 115A may be fluidically connected to the secondary conduit inlet 84C on the heat exchanger unit 80B, the primary fluid outlet pipe 113B may be fluidically connected to a first conduit outlet 82D on the heat exchanger unit 80B, and the secondary fluid outlet pipe 115B may be fluidically connected to the secondary conduit outlet 84D.

In some embodiments, the manifold, via its fluid inlet pipes, may be configured to flow a primary fluid stream into a plurality of first conduits in the heat exchanger units and/or to flow secondary fluid stream into a plurality of second conduits in the heat exchanger units. For example, in as shown in FIGS. 6C-6D, the manifold 89 may be configured to flow a primary fluid inlet stream 13A through the primary fluid inlet pipe 113A into the first conduit inlet 82C on the heat exchanger unit 80B and/or to flow a secondary fluid inlet stream 15A through the secondary fluid inlet pipe 115A into the second conduit inlet 84C on the heat exchanger unit 80B.

In some embodiments, the manifold, via its fluid outlet pipes, may be configured to receive a primary fluid stream exiting the plurality of first conduits in the heat exchanger units and/or to receive a secondary fluid exiting the plurality of second conduits in the heat exchanger units. For example, via the manifold 90 shown in FIGS. 6C-6D, the primary fluid outlet pipe 113B may be configured to receive a primary fluid outlet stream 13B exiting the first conduit outlet 82C of the heat exchanger unit 80B and/or the secondary fluid outlet pipe 115B may be configured to receive a secondary fluid outlet stream 15B exiting the second conduit out 84C on the heat exchanger unit 80B.

While FIG. 6D shows a manifold employed in a particular type of heat exchanger system (e.g., a heat exchanger system having a wound or coiled configuration), it should be noted that not all embodiments described herein are so limiting, and in other embodiments, a manifold may be employed in any of a variety of heat exchanger systems described herein and/or with respect to FIGS. 2-5. For example, although not shown in FIGS. 2-5, the various heat exchanger systems 30, 50, 60, and 70 may each comprise a manifold similar to that illustrated in FIG. 6D. For example, in FIGS. 2-5, a manifold (not shown) may comprise a primary fluid inlet pipe (e.g., an inlet pipe like the inlet pipe 113A in FIG. 6D) configured to flow the primary fluid 13 into the plurality of first conduits (e.g., first conduits 32, 52, 62, 72) and/or a secondary fluid inlet pipe (e.g., an inlet pipe like the inlet pipe 115A in FIG. 6D) configured to flow the secondary fluid 15 into the plurality of second conduits (e.g., second conduits 34, 54, 64, 74). Additionally or alternatively, the manifold (not shown) may further comprise a primary fluid outlet pipe (e.g., an outlet pipe like the outlet pipe 113B in FIG. 6D) configured to receive the primary fluid 13 exiting the plurality of first conduits (e.g., first conduits 32, 52, 62, 72) and/or a secondary fluid outlet pipe (e.g., an outlet pipe like the outlet pipe 115B in FIG. 6D) configured to receive the secondary fluid 15 exiting from the plurality of second conduits (e.g., second conduits 34, 54, 64, 74).

The heat exchanger unit and/or system 80A-80C described in FIGS. 6A-6D may have any of a variety of additional components and properties described previously, e.g., such as a gas flow device, a sweep gas, a primary fluid, a secondary fluid, a reactive material, etc. For example, the heat exchanger system and/or unit may further comprise a sweep gas (e.g., gas 20) surrounding the first conduit 82 and the second conduits 86. The sweep gas may have any property described previously. For example, the sweep gas may facilitate removal of tritium (e.g., via arrow 19 in FIG. 6A) from the primary fluid 13 and/or any tritium permeated into the connector 86 into the sweep gas 20. As such, the sweep gas 20 may contain tritium arising from the primary fluid 13.

As noted above, the heat exchanger system described herein may be employed for harnessing energy produced from a fusion reaction and for extraction and recycling of removed tritium. In some embodiments, the heat exchanger system may be a part of a fusion plant, or other plant such as described herein. A fusion reaction (e.g., deuterium-tritium fusion reaction) as illustrated by eqs. (1)-(2) may be carried out within the fusion plant.

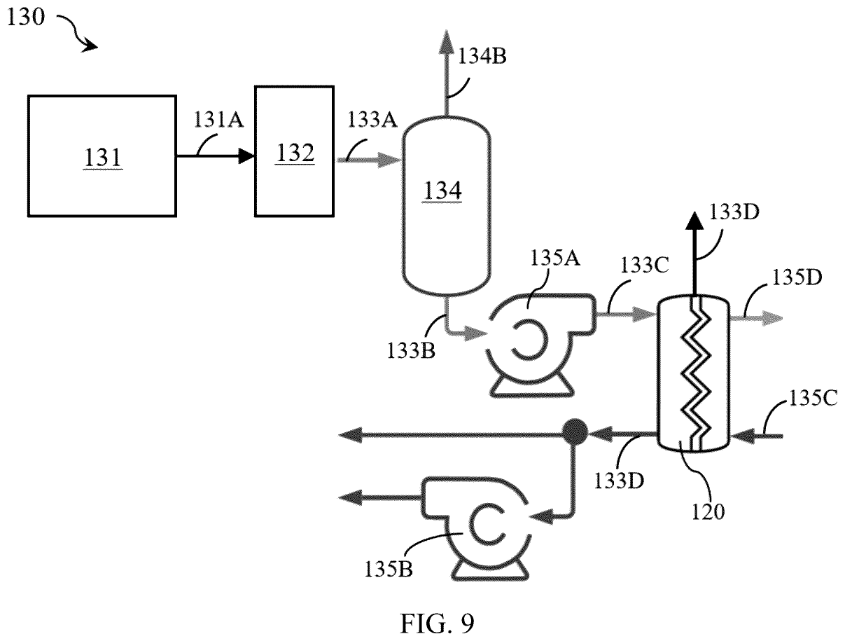

A non-limiting example of a fusion power plant comprising a heat exchanger system is shown in FIG. 9. For example, as shown in FIG. 9, in a fusion power plant 130, a fusion reaction (e.g., as illustrated by eq. (1)) may take place in a reactor 131 (e.g., such as in the plasma of the reactor). In some embodiments, the energy and neutron 131A released from the fusion reaction may be passed into a tritium breeding blanket 132, where the energy from the reaction may be stored as a thermal energy and additional tritium may be produced via a second reaction (e.g., as illustrated by eq. (2)). As a result, in some cases, the tritium breeding blanket 132 may contain a high-temperature fluid 133A comprising a relatively high amount of tritium.

In some embodiments, as shown in FIG. 9, the tritium-containing high-temperature fluid 133A (e.g., a primary fluid) may be subsequently fed to a heat exchanger system 120. By employing the heat exchanger system, the thermal energy stored within the tritium-containing high-temperature fluid 133A may be transferred to a processing fluid, e.g., a fluid that may be transferred out of the fusion power plant and subsequently used for power generation. Additionally, the tritium within the tritium-containing high-temperature fluid 133A may be effectively extracted and subsequently recycled by a sweep gas within the heat exchanger. The heat exchanger system 120 may be any of a variety of heat exchanger systems described herein. For example, the heat exchanger 120 may have any of a variety of components (e.g., first and second conduits, connector, sweep gas, reactive material) described and may be operated as described herein.

In some embodiments, the fusion power plant may optionally comprise a tritium extractor upstream of the heat exchanger system. The tritium extractor may be configured employ to perform a primary tritium extraction on the tritium-containing primary fluid prior to feeding the fluid into the heat exchanger. For example, as shown in FIG. 9, the fusion power plant may comprise as a tritium extractor 134 positioned upstream the heat exchanger 120. As the high-temperature fluid 133A flows through the tritium extractor 134, a substantially pure tritium extraction stream 134B and a high-temperature fluid 133B containing a relatively low amount tritium may be produced. In some instances, the tritium-containing high-temperature fluid 133B may be next pumped into the heat exchanger 120 via a pump 135A as a stream 113C.

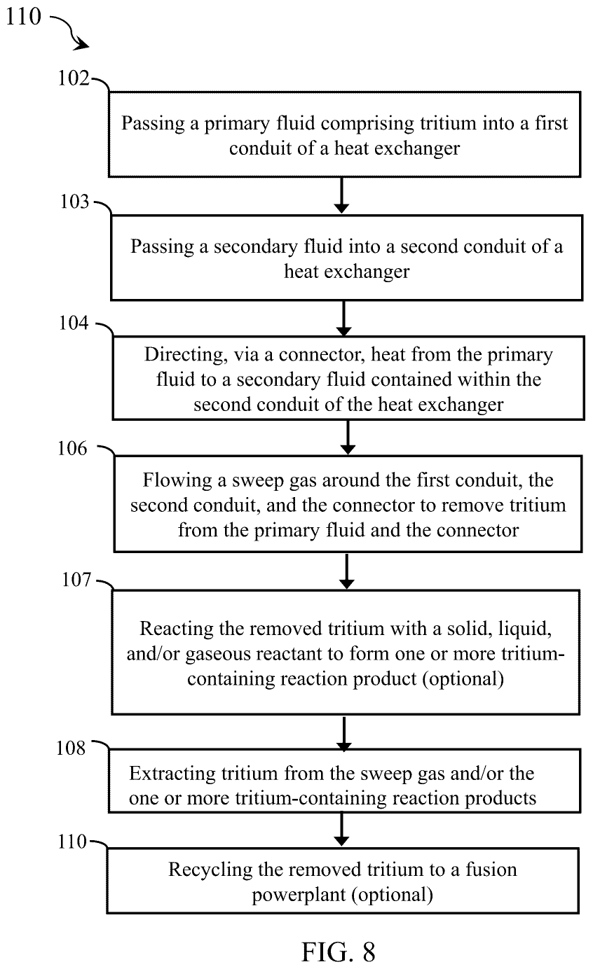

In some embodiments, the heat exchanger system may be employed to transfer heat from a tritium-containing primary fluid into a secondary fluid. For example, as shown in FIG. 9, a high-temperature tritium-containing fluid 133C (e.g., a primary fluid inlet stream) and a low-temperature processing fluid 135C (e.g., a secondary fluid inlet stream) may be passed into the heat exchanger 120 for heat exchange. As illustrated by step 104 of FIG. 8, within the heat exchanger 120, heat may be directed, via a connector (not shown), from the high-temperature tritium-containing fluid 133C (e.g., a primary fluid) to the low-temperature processing fluid 135C (e.g., a secondary fluid) contained within the second conduit of the heat exchanger. After passing through the heat exchanger 120, a high-temperature process fluid 135D (e.g., a secondary fluid output stream) and a low-temperature fluid 133D (e.g., a primary fluid output stream) may be produced. In some cases, the low temperature fluid 133D may be passed through a pump 135B and recycled into various parts of the fusion power plant 130, e.g., such as the tritium breeding blanket 132, etc.

In some embodiments, the heat exchanger system may be employed to remove tritium from the tritium-containing primary fluid into a sweep gas. For example, as shown in FIG. 9, a sweep gas (not shown) may be flowed around the first conduit, the second conduit, and the connector (not shown) to remove tritium from the high-temperature tritium-containing fluid 133C (e.g., a primary fluid). In some cases, the removed tritium may react with a reactive material (e.g., a solid, liquid, and/or gaseous reactant) within the heat exchanger and/or sweep gas to form one or more tritium-containing reaction products.

In some embodiments, the heat exchanger may be employed to extract tritium from the sweep gas and/or the one more tritium-containing reaction products (when formed). For example, as shown in FIG. 9, a stream 133D (e.g., a sweep gas containing the removed tritium and/or a stream containing one or more tritium-containing reaction products) may be produced from the heat exchanger system 120. The stream 133D may, in some cases, be passed to a tritium separator (not shown) for secondary tritium extraction. According to some embodiments, the extracted tritium may be recycled to the plasma of the fusion reactor 131 to participate in addition fusion reactions (e.g., a deuterium-tritium fusion reaction).

Certain aspects of the disclosure are related to a method of manufacturing a heat exchanger system, e.g., such as a heat exchanger system described herein.

In some embodiments, the method of manufacturing a heat exchanger system comprises forming a plurality of first conduits, e.g., as shown in step 92 of FIG. 7. The plurality of first conduits may be formed from materials (e.g., metal or metal alloy) having any of a variety of suitable shapes. For example, in one set of embodiments, the plurality of first conduits may be formed from pipes or tubes (e.g., metal pipes or tubes), e.g., as shown in FIG. 2, FIG. 4, and FIGS. 6A-6D.

In another set of embodiments, forming the plurality of first conduits comprises forming conduits from one or more sheets of metal or metal alloy, e.g., as shown in FIG. 3 and FIG. 5. For example, as shown in FIG. 5, forming the plurality of first conduits comprises forming two corrugated metal sheets (e.g., metal sheets 73A and 73B), and subsequently joining (e.g., bonding) the two corrugated metal sheets together at predetermined regions. In some embodiments, forming the one or more corrugated sheets of metal comprises rolling and/or extruding the one or more sheets of metal. The resulting plurality of first conduits may have any appropriate shapes, e.g., rectangular, polygonal, etc.

In yet another set embodiments, forming the plurality of first conduits comprises forming a plurality of channels on a surface of a first sheet of metal, and subsequently joining a surface of a second sheet of metal to the surface of the first sheet of metal to form sealed channels. A non-limiting example of an embodiment is illustrated in FIG. 3. As shown, a plurality of channels may be first formed on a surface of a first sheet of metal 53B. The plurality of channels may be formed via cutting and/or etching the surface of the first sheet of metal. The first sheet of metal 53B containing the plurality of channels may be subsequently joined to a surface of a second sheet of metal 53B to form sealed channels (i.e., first conduits 52). Any of a variety of methods may be employed to join the first sheet of metal to the surface second sheet of metal, including, but not limited to, brazing and/or diffusion welding.

In some embodiments, the method of manufacturing a heat exchanger system comprises forming at least one connector (e.g., a solid connector), e.g., as shown in step 94 of FIG. 7. The at least on connector may be formed from materials (e.g., metal or metal alloy) having any of a variety of suitable shapes. For example, in one set of embodiments, the at least one connector may be formed from one or more flat sheets of metal and/or metal alloy, e.g., as shown in FIGS. 2-6. In some embodiments, the connector may be formed from a single corrugated sheet of metal or metal alloy, e.g., as shown in FIGS. 3-4.

In some embodiments, forming the at least one connector comprises forming one or more corrugated sheets of metal and/or metal alloy, e.g., as shown in FIGS. 3-4. For example, the one or more corrugated sheets of metal may be formed by rolling and/or extruding the one or more sheets of metal and/or metal alloy.

In some embodiments, the method of manufacturing a heat exchanger system comprises forming a plurality of second conduits, e.g., as shown in step 96 of FIG. 7. The plurality of second conduits may be formed from materials (e.g., metal or metal alloy) having any of a variety of suitable shapes. For example, in one set of embodiments, the plurality of second conduits may be formed from pipes or tubes (e.g., metal pipes or tubes), e.g., as shown in FIGS. 2-4 and FIG. 6A-6C.

In another set of embodiments, forming the plurality of second conduits comprises forming conduits from one or more sheets of metal or metal alloy, e.g., as shown in FIG. 5. For example, in FIG. 5, forming the plurality of first conduits comprises forming two corrugated metal sheets (e.g., metal sheets 75A and 75B), and subsequently joining (e.g., bonding) the two corrugated metal sheets together at predetermined regions. The resulting plurality of first conduits may have any appropriate shapes, e.g., rectangular, polygonal, square, etc.

In some embodiments, the method of manufacturing comprises stacking the plurality of first conduits, the at least one solid connector, and the plurality of second conduits in alternating layers, e.g., as shown in step 98 of FIG. 7 and FIGS. 2-6. For example, according to some embodiments, the various components may be stacked in a way such that the at least one solid connector thermally couples the plurality of first conduits to the plurality of second conduits, e.g., as shown in FIGS. 2-6B.

For example, referring back to FIG. 3 as non-limiting example, upon forming a layer comprising the plurality of first conduits 52, the plurality of second conduits 54, and at least one corrugated connector sheet 56, the corrugated connector sheet 56 may be stacked on both sides of the layer comprising the plurality of first conduits 52. The plurality of second conduits 54 may in turn be stacked on the corrugated connector sheet 56 at a side opposite the layer comprising the plurality of first conduits 52. As such, the at least one corrugated connector 56 may thermally couple the plurality of first conduits 52 to the plurality of second conduits 54 in an alternating configuration.

In some embodiments, the method of manufacturing comprises joining the stacked alternating layers of first conduits, connectors, and second conduits, e.g., as shown in step 100 of FIG. 7. The stacked alternating layers may be joined via any appropriate methods described herein. In one set of embodiments, as shown in FIGS. 2-6B, the stacked alternating layers may be joined via brazing, welding, etc. In some cases, a brazing material, as shown in FIG. 4, may be introduced between the stacked layers to bond the stacked layers together.

Certain aspects of the present disclosure are directed to a method for using the heat exchanger system described herein. FIG. 8 shows a flow chart describing one non-limiting embodiment of such a method. The heat exchanger system may be any of the heat exchanger systems described herein. The heat exchanger system my comprise any of a variety of components described herein, including at least one (e.g., a plurality of) first conduit, at least (e.g., a plurality of) second conduit, and at least one (e.g., a plurality of) connector (e.g., a solid connector), a sweep gas, etc. As shown in step 102, a primary fluid comprising tritium may be passed into a first conduit of a heat exchanger system. Additionally, as shown in step 103, a secondary fluid may be passed into a second conduit of a heat exchanger system. As shown in step 104, heat from the primary fluid may be directed via a connector (e.g., a solid connector) to a secondary fluid contained within the second conduit of the heat exchanger. Next, as shown in step 106, a sweep gas (e.g., an inert sweep gas and/or a reactive sweep gas) may be flowed around the first conduit, the second conduit, and the connector to remove tritium from the primary fluid and the connector. As shown in step 107, the tritium from the primary fluid, when exiting from the external surface of the first conduit, may react with a reactive material described herein (e.g., a reactive solid, a reactive liquid, and/or a reactive gas) positioned external the first conduit to form one or more tritium-containing reaction products. As shown in step 108, tritium may be extracted from the sweep gas and/or a tritium-containing reaction product formed within the heat exchanger system. Optionally, as shown in step 110, the extracted tritium may be recycled to a fusion powerplant.

U.S. Provisional Patent Application Ser. No. 63/344,329, filed May 20, 2022, entitled “Tritium Shunt Heat Exchanger with Sweep Gas,” is incorporated herein by reference in its entirety.

The following examples are intended to illustrate certain embodiments of the present disclosure, but do not exemplify the full scope of the disclosure.

### Example 1

This example describes a heat exchanger system comprising alternating layers of first conduits and second conduits, in accordance with certain embodiments.

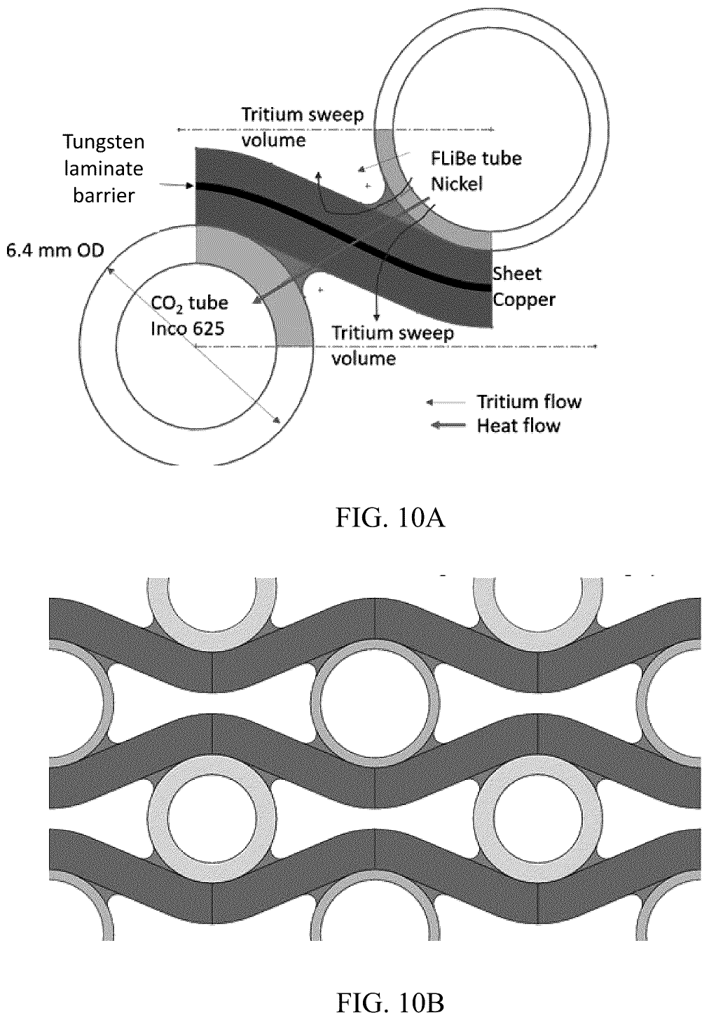

As shown in FIG. 10A, a heat exchanger unit cell may comprise a first conduit (e.g., a nickel tube) and a second conduit (e.g., an Inconel 625 tube having an outer diameter of 6.4 mm). The first conduit may contain a high-temperature FLiBe molten salt comprising tritium, and the second conduit may contain a low-temperature CO₂ process fluid. The first conduit may be thermally coupled to the second conduit via a sheet of copper/tungsten/copper laminate. A sweep gas may be flowed across the external surfaces of the first conduit, the second conduit, and the laminate. Via the laminate, heat may be conducted from the FLiBe molten salt to the CO₂ process fluid. The sweep gas may be capable of removing a majority of the tritium exiting the external surface of the first conduit.

The heat exchanger unit cell of FIG. 10A may be stacked into a heat exchanger system comprising alternating layers of tubes and copper sheets, e.g., as shown in 10B. The tubes and may be brazed bonded to the sheets via fillets.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the disclosure includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A heat exchanger system, comprising:
a first conduit;
a second conduit;
a solid connector thermally coupling an external surface of the first conduit to an external surface of the second conduit; and
a gas flow device, positioned to flow a gas around the first conduit, the second conduit, and the solid connector.

2. The heat exchanger system of claim 1, wherein the solid connector has a permeability to tritium of no more than 10⁻⁶ mol m⁻¹ s⁻¹ MPa^{-1/2} at a temperature of 850 K.

3. (canceled)

4. The heat exchanger system of claim 1, wherein the solid connector comprises a surface exposed to the gas and a cross-section perpendicular to a direction along which the solid connector extends from the first conduit to the second conduit, and wherein the solid connector has a surface area that is at least 0.5 times the cross-sectional area of the solid connector.

5. The heat exchanger system of claim 1, wherein the solid connector has a ratio of thermal conductivity to tritium permeability of at least 10¹⁰ N^{3/2} mol⁻¹ K⁻¹.

6. The heat exchanger of claim 1, wherein the solid connector comprises a metal and/or metal alloy.

7. The heat exchanger of claim 1, wherein the gas flow device comprises a pump and/or a fan.

8. (canceled)

9. A heat exchanger system, comprising:
a first conduit containing a primary fluid, wherein the primary fluid comprises tritium;
a second conduit containing a secondary fluid, wherein the secondary fluid comprises tritium at a lower concentration than the primary fluid;
a solid connector thermally coupling an external surface of the first conduit to an external surface of the second conduit; and
a sweep gas surrounding the first conduit, the second conduit, and the solid connector, wherein the sweep gas contains tritium arising from the primary fluid.

10. The heat exchanger system of claim 9, wherein the solid connector is constructed and arranged such that at least 50% of the tritium exiting the primary fluid diffuses into the sweep gas before reaching the secondary fluid.

11. (canceled)

12. The heat exchanger system of claim 9, wherein the primary fluid comprises a molten salt comprising lithium or a liquid metal comprising lithium.

13. (canceled)

14. The heat exchanger system of claim 9, wherein the primary fluid comprises water.

15. The heat exchanger system of claim 12, wherein the molten salt and/or the liquid metal comprises beryllium and/or lead.

16. (canceled)

17. The heat exchanger system of claim 9, wherein the primary fluid comprises at least 10⁻⁶ mol/m³ of tritium.

18. The heat exchanger system of claim 9, wherein the secondary fluid comprises a power cycle fluid and/or molten salt.

19-20. (canceled)

21. The heat exchanger system of claim 9, wherein the sweep gas comprises an inert sweep gas.

22. The heat exchanger system of claim 9, wherein the sweep gas comprises a reactive material.

23. (canceled)

24. The heat exchanger system of claim 9, wherein the sweep gas comprises a gas selected from the group consisting of oxygen, carbon dioxide, nitrogen, chlorine, fluorine, helium, argon, neon, krypton, and air.

25-63. (canceled)

64. A method, comprising:
passing a primary fluid comprising tritium into a first conduit of a heat exchanger;
directing, via a connector, heat from the primary fluid to a secondary fluid contained within the second conduit of the heat exchanger, wherein the connector thermally couples an external surface of the first conduit to an external surface of a second conduit; and
flowing a sweep gas around the first conduit, the second conduit, and the connector to remove tritium from the primary fluid and the connector.

65. The method of claim 64, wherein the sweep gas removes at least 50% of tritium exiting an external surface of the first conduit.

66. (canceled)

67. The method of claim 64, further comprising reacting the removed tritium with a solid, liquid, and/or gaseous reactant to form one or more tritium-containing reaction products.

68-69. (canceled)

70. The method claim 64, further comprising recycling the removed tritium to a fusion power plant.

71. (canceled)

72. The heat exchanger system of claim 1, wherein the solid connector comprises stainless steel.

73. The heat exchanger system of claim 9, wherein the solid connector comprises stainless steel.
